(19) United States
(12) Patent Application Publication
(10) Pub. No.: US 2014/0301436 A1
(43) Pub. Date: Oct. 9, 2014

(54) CROSS-LAYER ALIGNMENT IN MULTI-LAYER VIDEO CODING

(71) Applicant: QUALCOMM Incorporated, San Diego, CA (US)

(72) Inventors: Ye-Kui Wang, San Diego, CA (US); Adarsh Krishnan Ramasubramonian, San Diego, CA (US); Jianle Chen, San Diego, CA (US)

(73) Assignee: QUALCOMM Incorporated, San Diego, CA (US)

(21) Appl. No.: 14/230,853

(22) Filed: Mar. 31, 2014

Related U.S. Application Data
(60) Provisional application No. 61/809,258, filed on Apr. 5, 2013.

(51) Int. Cl. H04N 19/105; H04N 19/50; H04N 19/187

(52) U.S. Cl. CPC H04N 19/00024; H04N 19/00321; H04N 19/00569
USPC 375/240.02

(57) ABSTRACT

An apparatus for coding video information according to certain aspects includes a memory unit and a video processor in communication with the memory unit. The video processor is configured to identify a first picture included in the first set of pictures, wherein pictures within the first set of pictures having an output position after the output position of the first picture also have a decoding position after the decoding position of the first picture. The video processor is further configured to identify a second picture included in the second set of pictures, wherein pictures within the second set of pictures having an output position after the output position of the second pictures also have a decoding position after the decoding position of the second picture. The video processor is also configured to code the identified first picture and the identified second picture via one syntax element into one access unit.

### CROSS REFERENCE TO RELATED APPLICATIONS

This application claims priority to U.S. Provisional No. 61/809,258, filed Apr. 5, 2013, which is incorporated by reference in its entirety. Any and all priority claims identified in the Application Data Sheet, or any correction thereto, are hereby incorporated by reference under 37 C.F.R. §1.57.

### BACKGROUND

1. Field

This disclosure is related to the field of video coding, including single layer, multi-layer, scalable HEVC (SHVC), and multi-view HEVC (MV-HEVC).

2. Description of the Related Art

Digital video capabilities can be incorporated into a wide range of devices, including digital televisions, digital direct broadcast systems, wireless broadcast systems, personal digital assistants (PDAs), laptop or desktop computers, tablet computers, e-book readers, digital cameras, digital recording devices, digital media players, video gaming devices, video game consoles, cellular or satellite radio telephones, so-called “smart phones,” video teleconferencing devices, video streaming devices, and the like. Digital video devices implement video coding techniques, such as those described in the standards defined by MPEG-2, MPEG-4, ITU-T H.263, ITU-T H.264/MPEG-4, Part 10, Advanced Video Coding (AVC), the High Efficiency Video Coding (HEVC) standard presently under development, and extensions of such standards. The video devices may transmit, receive, encode, decode, and/or store digital video information more efficiently by implementing such video coding techniques.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs) and/or coding nodes. Video blocks in an intra-coded (I) slice of a picture are encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Video coding techniques include spatial (intra-picture) prediction and/or temporal (inter-picture) prediction to reduce or remove redundancy inherent in video sequences. For block-based video coding, a video slice (e.g., a video frame or a portion of a video frame) may be partitioned into video blocks, which may also be referred to as treeblocks, coding units (CUs), and/or coding nodes. CUs may be further partitioned into one or more prediction units (PUs) to determine predictive video data for the CU. The video compression techniques may also partition the CUs into one or more transform units (TUs) of residual video block data, which represents the difference between the video block to be coded and the predictive video data. Linear transforms, such as a two-dimensional discrete cosine transform (DCT), may be applied to a TU to transform the residual video block data from the pixel domain to the frequency domain to achieve further compression. Further, video blocks in an intra-coded (I) slice of a picture may be encoded using spatial prediction with respect to reference samples in neighboring blocks in the same picture. Video blocks in an inter-coded (P or B) slice of a picture may use spatial prediction with respect to reference samples in neighboring blocks in the same picture or temporal prediction with respect to reference samples in other reference pictures. Pictures may be referred to as frames, and reference pictures may be referred to a reference frames.

Spatial or temporal prediction results in a predictive block for a block to be coded. Residual data represents pixel differences between the original block to be coded and the predictive block. An inter-coded block is encoded according to a motion vector that points to a block of reference samples forming the predictive block, and the residual data indicating the difference between the coded block and the predictive block. An intra-coded block is encoded according to an intra-coding mode and the residual data. For further compression, the residual data may be transformed from the pixel domain to a transform domain, resulting in residual transform coefficients, which then may be quantized. The quantized transform coefficients, initially arranged in a two-dimensional array, may be scanned in order to produce a one-dimensional vector of transform coefficients, and entropy encoding may be applied to achieve even more compression.

Some coding implementations include video coded in multiple layers. Each layer may represent a differently encoded version of the video. With an eye toward providing a flexible standard, each layer may be given free rein on how to represent the coded video information. However, such freedom requires coding devices to handle the layered information which may be variously coded. This can introduce resource utilization overhead, such as processor cycle, memory, and/or power consumption, as the layers are organized and coded. Furthermore, this may introduce presentation delay as the layers of coded information are processed.

### SUMMARY OF THE DISCLOSURE

In general, this disclosure describes techniques related to video coding, particularly multi-layer video coding. The techniques described below provide several coding features which enhance the resource utilization needed for multi-layer video processing.

In one innovative aspect, an apparatus for coding video information is provided. The apparatus includes a memory unit configured to store a first set of pictures included in a base layer and a second set of pictures included in an enhancement layer. The first set of pictures and the second set of pictures providing different representations of the video information. Furthermore, the first set of pictures and the second set of pictures have an output order for pictures included in the respective set. The output order identifies a display sequence for the pictures, each picture having an output position within the associated output order. The first set of pictures and the second set of picture have a decoding order for pictures included in the respective set. The decoding order identifies a decoding sequence for the pictures included in the respective set. Each picture further has a decoding position within the associated decoding order.

The apparatus also includes a video processor operationally coupled to the memory unit. The video processor is configured to identify a first picture included in the first set of pictures, wherein pictures within the first set of pictures having an output position after the output position of the first picture also have a decoding position after the decoding position of the first picture. The video processor is further configured to identify a second picture included in the second set of pictures, wherein pictures within the second set of pictures having an output position after the output position of the second pictures also have a decoding position after the decoding position of the second picture. The video processor is further configured to code the identified first picture and the identified second picture into one access unit.

In some implementations, the first set of pictures includes a first group of pictures and the second set of pictures comprises a second group of pictures. The pictures from the first set of pictures having output positions before the output position of the identified first picture and having decoding positions after the decoding position of the identified first picture may also have decoding positions prior to a third picture included in a third set of pictures included in the base layer. Pictures within the third set of pictures having output positions after the output position of the third picture may also have a decoding position after the decoding position of the third picture. The pictures from the second set of pictures having output positions before the output position of the identified second picture and having decoding positions after the decoding position of the identified second picture may also have decoding positions prior to a fourth picture included in a fourth set of pictures included in the enhancement layer, wherein pictures within the fourth set of pictures have output positions after the output position of the fourth picture also have decoding positions after the decoding position of the fourth picture.

The first picture and the second picture may be intra-coded random access point pictures. The access unit may be a first access unit for the video information, and the access unit may include a picture for each layer included the video information. In some implementations of the apparatus, a picture associated with a layer other than the base layer may not be coded as an intra-coded random access point picture unless, for each layer below the layer for the picture that has at least one picture in the video information there is a picture in the access unit.

The apparatus may include encoder configured to generate the access unit configured to align the pictures associated with the layers of an access unit. Some implementations of the apparatus may include a decoder configured to process the access unit configured to align the pictures associated with the layers of an access unit. The apparatus may include a desktop computer, a notebook computer, a laptop computer, a tablet computer, a set-top box, a telephone handset, a television, a camera, a display device, a digital media player, a video gaming console, an in-car computer, or a video streaming device.

In a further innovative aspect, a method of encoding video information is provided. The method includes storing a first set of pictures included in a base layer and a second set of pictures included in an enhancement layer. The first set of pictures and the second set of pictures provide different representations of the video information. Furthermore, the first set of pictures and the second set of pictures have an output order for pictures included in the respective set, where the output order identifies a display sequence for the pictures. Each picture has an output position within the associated output order. The first set of pictures and the second set of picture each have a decoding order for pictures included in the respective set. The decoding order identifies a decoding sequence for the pictures included in the respective set. Each picture further has a decoding position within the associated decoding order.

The method also includes identifying a first picture included in the first set of pictures. Pictures within the first set of pictures having an output position after the output position of the first picture also have a decoding position after the decoding position of the first picture. The method also includes identifying a second picture included in the second set of pictures. Pictures within the second set of pictures having an output position after the output position of the second pictures also have a decoding position after the decoding position of the second picture. The method also includes encoding the identified first picture and the identified second picture in one access unit.

The first set of pictures comprises a first group of pictures and the second set of pictures comprises a first group of pictures and a second group of pictures. The first picture and the second picture may be intra-coded random access point pictures. The access unit, in some implementations of the video encoding method, is a first access unit for the video information, and the access unit includes a picture for each layer included the video information. In some implementations, a picture associated with a layer other than the base layer may not be coded as an intra-coded random access point picture unless, for each layer below the layer for the picture that has at least one picture in the video information there is a picture in the access unit.

In some implementations of the video encoding method, the first set of pictures includes a first group of pictures and the second set of pictures comprises a second group of pictures. The pictures from the first set of pictures having output positions before the output position of the identified first picture and having decoding positions after the decoding position of the identified first picture may also have decoding positions prior to a third picture included in a third set of pictures included in the base layer. Pictures within the third set of pictures having output positions after the output position of the third picture may also have a decoding position after the decoding position of the third picture. The pictures from the second set of pictures having output positions before the output position of the identified second picture and having decoding positions after the decoding position of the identified second picture may also have decoding positions prior to a fourth picture included in a fourth set of pictures included in the enhancement layer, wherein pictures within the fourth set of pictures have output positions after the output position of the fourth picture also have decoding positions after the decoding position of the fourth picture.

In an innovative aspect, a non-transitory computer-readable medium comprising instructions executable by a processor of an apparatus is provided. The instructions cause the apparatus to perform the video encoding method described above.

In yet another innovative aspect, a method of decoding video information is provided. The method includes receiving a first portion of the video information including two or more layers of pictures, where each layer of pictures has an output order for pictures included in the respective layer. The output order identifies a display sequence for the pictures, each picture having an output position within the associated output order. Furthermore, the first set of pictures and the second set of picture have a decoding order for pictures included in the respective set, the decoding order identifying a decoding sequence for the pictures included in the respective set. Each picture further has a decoding position within the associated decoding order.

The method also includes identifying key pictures, a key picture being a picture having no other picture having an output position following the output position of the picture from pictures included in a layer associated with the picture which have a decoding position that is prior to the decoding position of the picture. The method further includes decoding the video information based on a determination as to whether all pictures included in an access unit are identified key pictures.

In one innovative aspect, a non-transitory computer-readable medium comprising instructions executable by a processor of an apparatus is provided. The instructions cause the apparatus to perform the video decoding method described above.

Upon determining that all pictures included in the access unit are identified key pictures or that all pictures included in the access unit are not identified key pictures, the method may include configuring a decoding pipeline for cross-layer aligned decoding. The method may include, in some implementations, identifying key pictures wherein the pictures from a first set of pictures from a layer having output positions before the output position of the key picture and having decoding positions after the decoding position of the identified key picture also have decoding positions prior to another key picture included in the layer, wherein the another key picture is the next identified key picture in output order after the key picture. In such implementations, the first set of pictures comprises a first group of pictures included in a layer.

A picture associated with a layer other than a base layer may not be coded as an intra-coded random access point picture unless, for each layer below the layer for the picture that has at least one picture in the video information there is a picture in the access unit.

In some implementations of this method, the identifying is selectively performed. The identifying may be selectively performed based on an operational characteristic of a decoding device performing the method. The operational characteristic may include the decoding device processing load, thermal state, bandwidth capacity, memory capacity, or coupled hardware.

Some implementations of the method may include storing the determination as to whether all pictures included in an access unit are identified key pictures. The method may then include selectively performing the identifying based on a duration of time elapsed since the determination.

In a further innovative aspect, an apparatus for coding video information is provided. The apparatus includes means for storing a first set of pictures included in a base layer and a second set of pictures included in an enhancement layer. The first set of pictures and the second set of pictures provide different representations of the video information. The first set of pictures and the second set of pictures each have an output order for pictures included in the respective set, the output order identifying a display sequence for the pictures. Each picture has an output position within the associated output order. The first set of pictures and the second set of pictures have a decoding order for pictures included in the respective set, the decoding order identifying a decoding sequence for the pictures included in the respective set. Each picture further has a decoding position within the associated decoding order.

The apparatus further includes means for identifying a first picture included in the first set of pictures and for identifying a second picture included in the second set of pictures. Pictures within the first set of pictures having an output position after the output position of the first picture also have a decoding position after the decoding position of the first picture. Pictures within the second set of pictures having an output position after the output position of the second pictures also have a decoding position after the decoding position of the second picture. The apparatus also includes means for coding the identified first picture and the identified second picture into one access unit.

In some implementations of the apparatus, the first set of pictures comprises a first group of pictures and the second set of pictures comprises a first group of pictures and a second group of pictures. The access unit may include a first access unit for the video information, and wherein the access unit may include a picture for each layer included the video information. It may be desirable for a picture associated with a layer other than the base layer to not be coded as an intra-coded random access point picture unless, for each layer below the layer for the picture that has at least one picture in the video information there is a picture in the access unit.

The details of one or more examples are set forth in the accompanying drawings and the description below, which are not intended to limit the full scope of the inventive concepts described herein. Other features, objects, and advantages will be apparent from the description and drawings, and from the claims.

### BRIEF DESCRIPTION OF THE DRAWINGS

Throughout the drawings, reference numbers may be re-used to indicate correspondence between referenced elements. The drawings are provided to illustrate example embodiments described herein and are not intended to limit the scope of the disclosure.

FIG. 1 shows a dimensionality diagram including example video scalabilities along different dimensions.

FIG. 2 illustrates a coding structure diagram of an exemplary multilayer coding structure.

FIG. 3 illustrates an access unit diagram for a bitstream including coded multilayer video data.

FIG. 4 is a block diagram illustrating an example video encoding and decoding system that may utilize techniques in accordance with aspects described in this disclosure.

FIG. 5 is a block diagram illustrating an example of a video encoder that may implement techniques in accordance with aspects described in this disclosure.

FIG. 6 is a block diagram illustrating an example of a cross-layer alignment processor that may implement techniques in accordance with aspects described in this disclosure.

FIG. 7 is a block diagram illustrating an example of a video decoder that may implement techniques in accordance with aspects described in this disclosure.

FIG. 8 illustrates an example of unaligned coded access units.

FIG. 9 illustrates a further example of unaligned coded access units.

FIG. 10 illustrates an example of aligned coded access units.

FIG. 11 illustrates a process flow diagram for a method of video coding.

FIG. 12 shows a process flow diagram for another method of video coding including cross-layer alignment.

FIG. 13 shows a process flow diagram for a method of identifying cross-layer aligned video data.

### DETAILED DESCRIPTION OF SPECIFIC EMBODIMENTS

The techniques described in this disclosure generally relate to video coding, particularly to multi-layer video coding, including scalable video coding and multiview/3D video coding. For example, the techniques may be related to, and used with or within, a High Efficiency Video Coding (HEVC) scalable video coding extension (referred to as SHVC). In an SHVC extension, there could be multiple layers of video information. The layer at the very bottom level may serve as a base layer (BL), and the layer at the very top (or the highest layer) or a layer in between may serve as an enhanced layer (EL). The “enhanced layer” is sometimes referred to as an “enhancement layer,” and these terms may be used interchangeably. The base layer or a layer in between the base layer and the highest layer is sometimes referred to as a “reference layer,” (RL) and these terms may also be used interchangeably. All layers in between the base layer and the top layer may serve as either or both ELs or reference layers (RLs). For example, a layer in the middle may be an EL for the layers below it, such as the base layer or any intervening enhancement layers, and at the same time serve as a RL for the enhancement layers above it. Each layer in between the base layer and the top layer (or the highest layer) may be used as a reference for inter-layer prediction by a higher layer and may use a lower layer as a reference for inter-layer prediction.

For purposes of illustration only, the techniques described in the disclosure are described with examples including only two layers (e.g., lower level layer such as the base layer, and a higher level layer such as the enhanced layer). It should be understood that the examples described in this disclosure can be extended to examples with multiple enhancement layers as well. In addition, for ease of explanation, the following disclosure mainly uses the terms “frames” or “blocks.” However, these terms are not meant to be limiting. For example, the techniques described below can be used with different video units, such as blocks (e.g., CU, PU, TU, macroblocks, etc.), slices, frames, etc., and the terms “picture” and “frame” may be used interchangeably.

### Video Coding

Video coding standards include ITU-T H.261, ISO/IEC MPEG-1 Visual, ITU-T H.262 or ISO/IEC MPEG-2 Visual, ITU-T H.263, ISO/IEC MPEG-4 Visual and ITU-T H.264 (also known as ISO/IEC MPEG-4 AVC), including its Scalable Video Coding (SVC) and Multiview Video Coding (MVC) extensions. In addition, a new video coding standard, namely High Efficiency Video Coding (HEVC), is being developed by the Joint Collaboration Team on Video Coding (JCT-VC) of ITU-T Video Coding Experts Group (VCEG) and ISO/IEC Motion Picture Experts Group (MPEG). Another recent draft of the HEVC standard, referred to as “HEVC Working Draft 7” is document HCTVC-I1003, Bross et al., “High Efficiency Video Coding (HEVC) Text Specification Draft 7,” Joint Collaborative Team on Video Coding (JCT-VC) of ITU-T SG16 WP3 and ISO/IEC JTC1/SC29/WG11, 9th Meeting: Geneva, Switzerland, Apr. 27, 2012 to May 7, 2012. Another recent draft, referred to as Working Draft 8, is available at the latest Working Draft (WD) of HEVC, and referred to as HEVC WD8 hereinafter.

One example of a multilayer coding standard is scalable video coding. Scalable video coding (SVC) may be used to provide quality (also referred to as signal-to-noise (SNR)) scalability, spatial scalability and/or temporal scalability. For example, in one embodiment, a reference layer (e.g., a base layer) includes video information sufficient to display a video at a first quality level and the enhancement layer includes additional video information relative to the reference layer such that the reference layer and the enhancement layer together include video information sufficient to display the video at a second quality level higher than the first level (e.g., less noise, greater resolution, better frame rate, etc.). An enhanced layer may have different spatial resolution than a base layer. For example, the spatial aspect ratio between EL and BL can be 1.0, 1.5, 2.0, or other different ratios. In other words, the spatial aspect of the EL may equal 1.0, 1.5, or 2.0 times the spatial aspect of the BL. In some examples, the scaling factor of the EL may be greater than the BL. For example, a size of pictures in the EL may be greater than a size of pictures in the BL. In this way, it may be possible, although not a limitation, that the spatial resolution of the EL is larger than the spatial resolution of the BL.

However, current techniques do not provide for alignment of key pictures across layers. Such techniques, as described in greater detail below, would enable better coding efficiency and reduced computational resources.

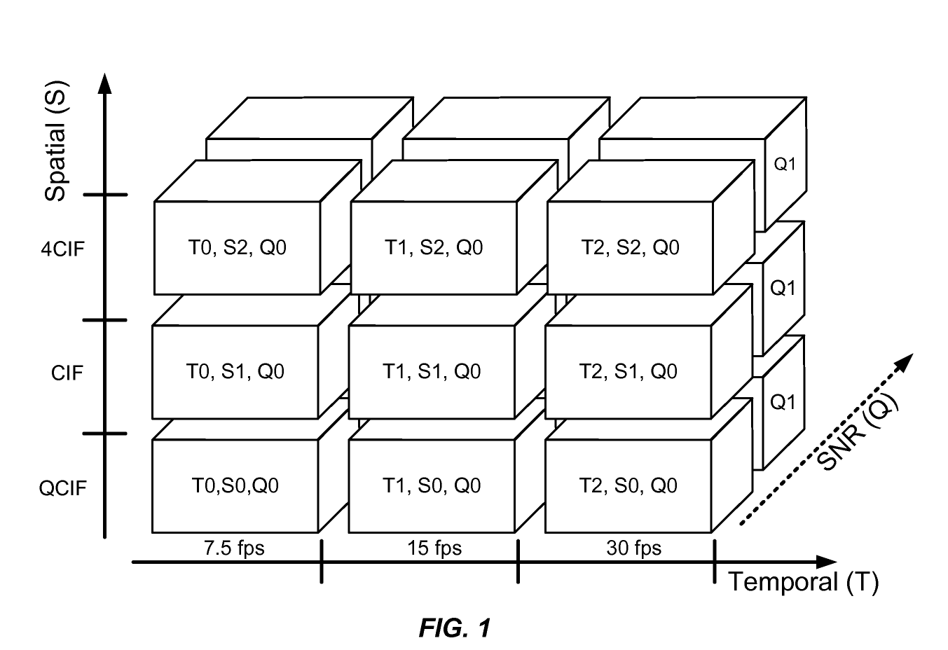

FIG. 1 shows a dimensionality diagram including example video scalabilities along different dimensions. Scalabilities, as shown in FIG. 1, are enabled in three dimensions. In a time dimension, frame rates such as 7.5 Hz, 15 Hz, or 30 Hz can be supported by temporal scalability (T). When a spatial scalability (S) is supported, different resolutions such as QCIF, CIF, and 4CIF are enabled. For each specific spatial resolution and frame rate, the SNR (Q) layers can be added to improve the picture quality.

Once video content has been encoded in such a scalable way, an extractor tool may be used to adapt the actual delivered content according to application requirements, which are dependent e.g., on the clients or the transmission channel. In the example shown in FIG. 1, each cube contains the pictures with the same frame rate (temporal level), spatial resolution and SNR layers Improved representations can be achieved by adding those cubes (e.g., pictures) in any dimension. Combined scalability is supported when there are two, three, or even more scalabilities enabled.

According to the SVC specification, the pictures with the lowest spatial and quality layer are compatible with H.264/AVC, and the pictures at the lowest temporal level form the temporal base layer, which can be enhanced with pictures at higher temporal levels. In addition to the H.264/AVC compatible layer, several spatial, and/or SNR enhancement layers can be added to provide spatial and/or quality scalabilities. SNR scalability is also referred as quality scalability. Each spatial or SNR enhancement layer itself may be temporally scalable, with the same temporal scalability structure as the H.264/AVC compatible layer. For one spatial or SNR enhancement layer, the lower layer it depends on is also referred as the base layer of that specific spatial or SNR enhancement layer.

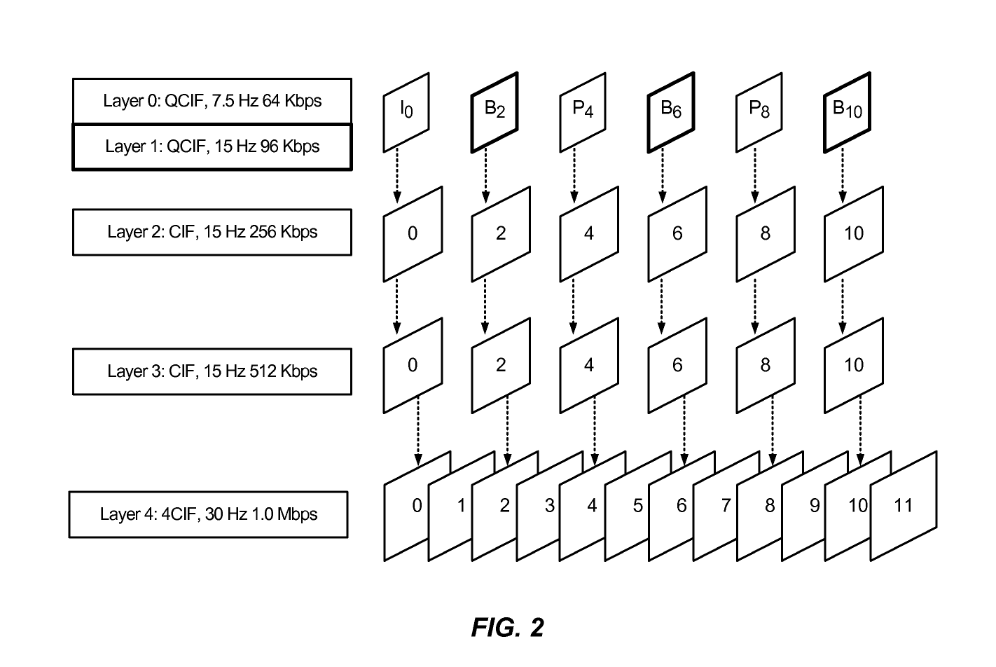

FIG. 2 illustrates a coding structure diagram of an exemplary multilayer coding structure. The pictures with the lowest spatial and quality layer (pictures in layer 0 and layer 1, with QCIF resolution) are compatible with H.264/AVC. Among them, those pictures of the lowest temporal level form the temporal base layer, as shown in layer 0 of FIG. 2. This temporal base layer (layer 0) can be enhanced with pictures of higher temporal levels (layer 1). In addition to the H.264/AVC compatible layer, several spatial and/or SNR enhancement layers can be added to provide spatial and/or quality scalabilities. For instance, the enhancement layer can be a CIF representation with the same resolution as layer 2. In the example, layer 3 is a SNR enhancement layer. As shown in the example, each spatial or SNR enhancement layer itself may be temporally scalable, with the same temporal scalability structure as the H.264/AVC compatible layer. Also, an enhancement layer can enhance both spatial resolution and frame rate. For example, layer 4 provides a 4CIF enhancement layer, which further increases the frame rate from 15 Hz to 30 Hz.

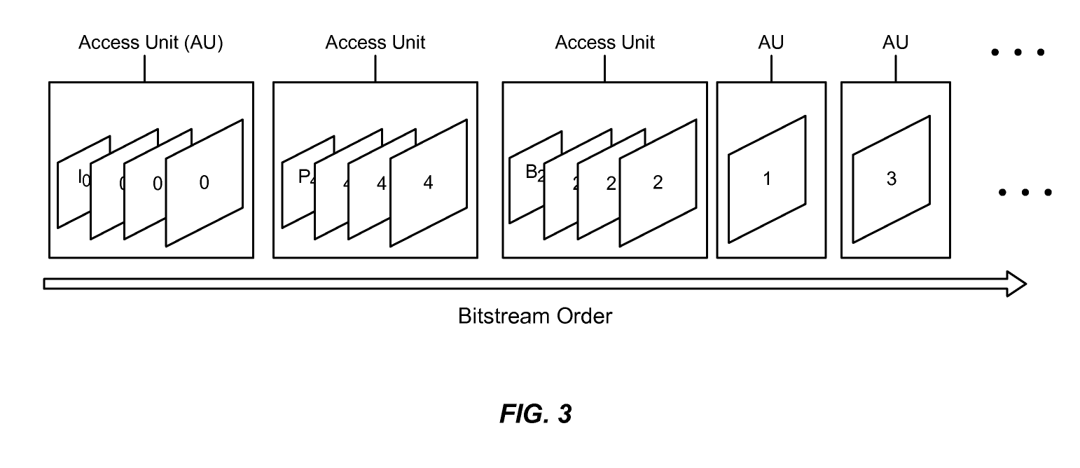

FIG. 3 illustrates an access unit diagram for a bitstream including coded multilayer video data. The coded slices in the same time instance are successive in the bitstream order. The slices form one access unit in the context of SVC. Those access units then follow the decoding order, which could be different from the display order and decided e.g., by the temporal prediction relationship.

Generally, inter-layer texture prediction refers to the case wherein the reconstructed base layer pixel value is used to predict the pixel value in the enhancement layer. There are two approaches “Intra-BL mode” and “Inter-layer reference picture.”

How the pictures are coded (e.g., prediction used) and packaged within the bitstream can impact the resources consumed to transmit, decode, and process the video data. The complexity of organizing the pictures in a bitstream is further increased as the number of layers included in the bitstream is increased. Systems, devices, and methods for cross-layer alignment of pictures from various layers are described in further detail below. The described features can reduce the resources needed to process the video information and improve overall system performance.

Various aspects of the novel systems, apparatuses, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of, or combined with, any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

### Video Coding System

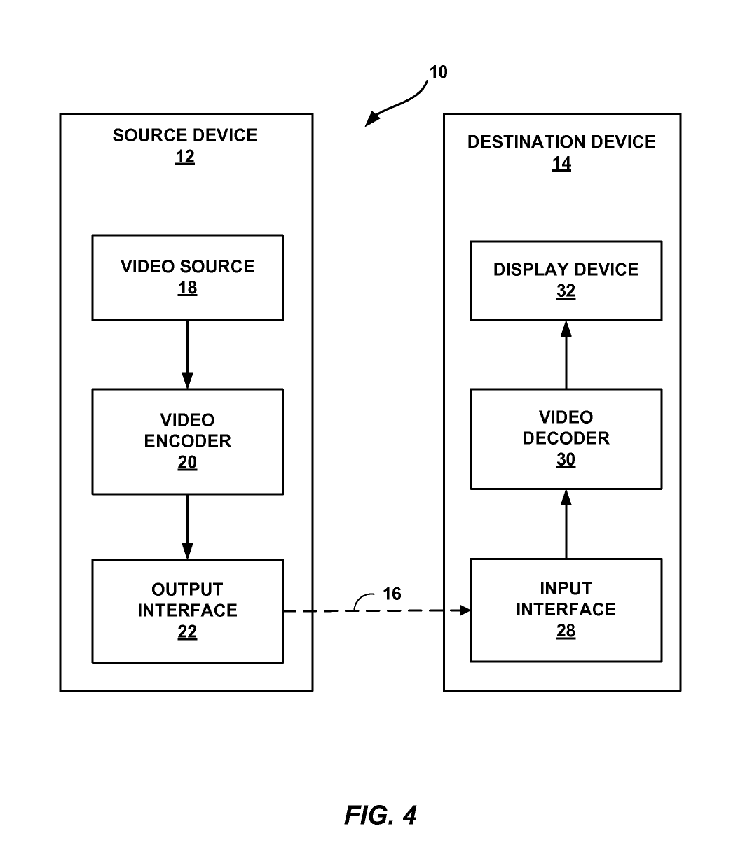

FIG. 4 is a block diagram that illustrates an example video coding system 10 that may utilize techniques in accordance with aspects described in this disclosure. As used described herein, the term “video coder” refers generically to both video encoders and video decoders. In this disclosure, the terms “video coding” or “coding” may refer generically to video encoding and video decoding.

As shown in FIG. 4, video coding system 10 includes a source device 12 and a destination device 14. Source device 12 generates encoded video data. Destination device 14 may decode the encoded video data generated by source device 12. Source device 12 can provide the video data to the destination device 14 via a computer-readable medium 16. Source device 12 and destination device 14 may include a wide range of devices, including desktop computers, notebook (e.g., laptop) computers, tablet computers, set-top boxes, telephone handsets, such as so-called “smart” phones, so-called “smart” pads, televisions, cameras, display devices, digital media players, video gaming consoles, in-car computers, video streaming devices, or the like. Source device 12 and destination device 14 may be equipped for wireless communication.

Destination device 14 may receive the encoded video data to be decoded via computer-readable medium 16. Computer-readable medium 16 may comprise a type of medium or device capable of moving the encoded video data from source device 12 to destination device 14. For example, computer-readable medium 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise a wireless or wired communication medium, such as a radio frequency (RF) spectrum or one or more physical transmission lines. The communication medium may form part of a packet-based network, such as a local area network, a wide-area network, or a global network, such as the Internet. The communication medium may include routers, switches, base stations, or other equipment that may be useful to facilitate communication from source device 12 to destination device 14.

In some embodiments, encoded data may be output from output interface 22 to a storage device. Similarly, encoded data may be accessed from the storage device by input interface. The storage device may include any of a variety of distributed or locally accessed data storage media such as a hard drive, Blu-ray discs, DVDs, CD-ROMs, flash memory, volatile or non-volatile memory, or other digital storage media for storing video data. The storage device may correspond to a file server or another intermediate storage device that may store the encoded video generated by source device 12. Destination device 14 may access stored video data from the storage device via streaming or download. The file server may be a type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through a standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the storage device may be a streaming transmission, a download transmission, or a combination thereof.

The techniques of this disclosure can apply applications or settings in addition to wireless applications or settings. The techniques may be applied to video coding in support of a of a variety of multimedia applications, such as over-the-air television broadcasts, cable television transmissions, satellite television transmissions, Internet streaming video transmissions, such as dynamic adaptive streaming over HTTP (DASH), digital video that is encoded onto a data storage medium, decoding of digital video stored on a data storage medium, or other applications. In some embodiments, system 10 may be configured to support one-way or two-way video transmission to support applications such as video streaming, video playback, video broadcasting, and/or video telephony.

In FIG. 4, source device 12 includes video source 18, video encoder 20, and output interface 22. Destination device 14 includes input interface 28, video decoder 30, and display device 32. Video encoder 20 of source device 12 may be configured to apply the techniques for coding a bitstream including video data conforming to multiple standards or standard extensions. In other embodiments, a source device and a destination device may include other components or arrangements. For example, source device 12 may receive video data from an external video source 18, such as an external camera. Likewise, destination device 14 may interface with an external display device, rather than including an integrated display device.

Video source 18 of source device 12 may include a video capture device, such as a video camera, a video archive containing previously captured video, and/or a video feed interface to receive video from a video content provider. Video source 18 may generate computer graphics-based data as the source video, or a combination of live video, archived video, and computer-generated video. In some embodiments, if video source 18 is a video camera, source device 12 and destination device 14 may form so-called camera phones or video phones. The captured, pre-captured, or computer-generated video may be encoded by video encoder 20. The encoded video information may be output by output interface 22 to a computer-readable medium 16.

Computer-readable medium 16 may include transient media, such as a wireless broadcast or wired network transmission, or storage media (e.g., non-transitory storage media), such as a hard disk, flash drive, compact disc, digital video disc, Blu-ray disc, or other computer-readable media. A network server (not shown) may receive encoded video data from source device 12 and provide the encoded video data to destination device 14 (e.g., via network transmission). A computing device of a medium production facility, such as a disc stamping facility, may receive encoded video data from source device 12 and produce a disc containing the encoded video data. Therefore, computer-readable medium 16 may be understood to include one or more computer-readable media of various forms.

Input interface 28 of destination device 14 can receive information from computer-readable medium 16. The information of computer-readable medium 16 may include syntax information defined by video encoder 20, which can be used by video decoder 30, that includes syntax elements that describe characteristics and/or processing of blocks and other coded units, e.g., GOPs. Display device 32 displays the decoded video data to a user, and may include any of a variety of display devices such as a cathode ray tube (CRT), a liquid crystal display (LCD), a plasma display, an organic light emitting diode (OLED) display, or another type of display device.

Video encoder 20 and video decoder 30 may operate according to a video coding standard, such as the High Efficiency Video Coding (HEVC) standard presently under development, and may conform to the HEVC Test Model (HM). Alternatively, video encoder 20 and video decoder 30 may operate according to other proprietary or industry standards, such as the ITU-T H.264 standard, alternatively referred to as MPEG-4, Part 10, Advanced Video Coding (AVC), or extensions of such standards. The techniques of this disclosure, however, are not limited to any particular coding standard. Other examples of video coding standards include MPEG-2 and ITU-T H.263. Although not shown in FIG. 4, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

Video encoder 20 and video decoder 30 each may be implemented as any of a variety of suitable encoder circuitry, such as one or more microprocessors, digital signal processors (DSPs), application specific integrated circuits (ASICs), field programmable gate arrays (FPGAs), discrete logic, software, hardware, firmware or any combinations thereof. When the techniques are implemented partially in software, a device may store instructions for the software in a non-transitory computer-readable medium and execute the instructions in hardware using one or more processors to perform the techniques of this disclosure. Each of video encoder 20 and video decoder 30 may be included in one or more encoders or decoders, either of which may be integrated as part of a combined encoder/decoder (CODEC) in a respective device. A device including video encoder 20 and/or video decoder 30 may comprise an integrated circuit, a microprocessor, and/or a wireless communication device, such as a cellular telephone.

The JCT-VC is working on development of the HEVC standard. The HEVC standardization efforts are based on an evolving model of a video coding device referred to as the HEVC Test Model (HM). The HM presumes several additional capabilities of video coding devices relative to existing devices according to, e.g., ITU-T H.264/AVC. For example, whereas H.264 provides nine intra-prediction encoding modes, the HM may provide as many as thirty-three intra-prediction encoding modes.

In general, the working model of the HM describes that a video frame or picture may be divided into a sequence of treeblocks or largest coding units (LCU) that include both luma and chroma samples. Syntax data within a bitstream may define a size for the LCU, which is a largest coding unit in terms of the number of pixels. A slice includes a number of consecutive treeblocks in coding order. A video frame or picture may be partitioned into one or more slices. Each treeblock may be split into coding units (CUs) according to a quadtree. In general, a quadtree data structure includes one node per CU, with a root node corresponding to the treeblock. If a CU is split into four sub-CUs, the node corresponding to the CU includes four leaf nodes, each of which corresponds to one of the sub-CUs.

Each node of the quadtree data structure may provide syntax data for the corresponding CU. For example, a node in the quadtree may include a split flag, indicating whether the CU corresponding to the node is split into sub-CUs. Syntax elements for a CU may be defined recursively, and may depend on whether the CU is split into sub-CUs. If a CU is not split further, it is referred as a leaf-CU. In this disclosure, four sub-CUs of a leaf-CU will also be referred to as leaf-CUs even if there is no explicit splitting of the original leaf-CU. For example, if a CU at 16×16 size is not split further, the four 8×8 sub-CUs will also be referred to as leaf-CUs although the 16×16 CU was never split.

A CU has a similar purpose as a macroblock of the H.264 standard, except that a CU does not have a size distinction. For example, a treeblock may be split into four child nodes (also referred to as sub-CUs), and each child node may in turn be a parent node and be split into another four child nodes. A final, unsplit child node, referred to as a leaf node of the quadtree, comprises a coding node, also referred to as a leaf-CU. Syntax data associated with a coded bitstream may define a maximum number of times a treeblock may be split, referred to as a maximum CU depth, and may also define a minimum size of the coding nodes. Accordingly, a bitstream may also define a smallest coding unit (SCU). This disclosure uses the term “block” to refer to any of a CU, PU, or TU, in the context of HEVC, or similar data structures in the context of other standards (e.g., macroblocks and sub-blocks thereof in H.264/AVC).

A CU includes a coding node and prediction units (PUs) and transform units (TUs) associated with the coding node. A size of the CU corresponds to a size of the coding node and must be square in shape. The size of the CU may range from 8×8 pixels up to the size of the treeblock with a maximum of 64×64 pixels or greater. Each CU may contain one or more PUs and one or more TUs. Syntax data associated with a CU may describe, for example, partitioning of the CU into one or more PUs. Partitioning modes may differ between whether the CU is skip or direct mode encoded, intra-prediction mode encoded, or inter-prediction mode encoded. PUs may be partitioned to be non-square in shape. Syntax data associated with a CU may also describe, for example, partitioning of the CU into one or more TUs according to a quadtree. A TU can be square or non-square (e.g., rectangular) in shape.

The HEVC standard allows for transformations according to TUs, which may be different for different CUs. The TUs are typically sized based on the size of PUs within a given CU defined for a partitioned LCU, although this may not always be the case. The TUs are typically the same size or smaller than the PUs. In some examples, residual samples corresponding to a CU may be subdivided into smaller units using a quadtree structure known as “residual quad tree” (RQT). The leaf nodes of the RQT may be referred to as transform units (TUs). Pixel difference values associated with the TUs may be transformed to produce transform coefficients, which may be quantized.

A leaf-CU may include one or more prediction units (PUs). In general, a PU represents a spatial area corresponding to all or a portion of the corresponding CU, and may include data for retrieving a reference sample for the PU. Moreover, a PU includes data related to prediction. For example, when the PU is intra-mode encoded, data for the PU may be included in a residual quadtree (RQT), which may include data describing an intra-prediction mode for a TU corresponding to the PU. As another example, when the PU is inter-mode encoded, the PU may include data defining one or more motion vectors for the PU. The data defining the motion vector for a PU may describe, for example, a horizontal component of the motion vector, a vertical component of the motion vector, a resolution for the motion vector (e.g., one-quarter pixel precision or one-eighth pixel precision), a reference picture to which the motion vector points, and/or a reference picture list (e.g., List 0, List 1, or List C) for the motion vector.

A leaf-CU having one or more PUs may also include one or more transform units (TUs). The transform units may be specified using an RQT (also referred to as a TU quadtree structure), as discussed above. For example, a split flag may indicate whether a leaf-CU is split into four transform units. Then, each transform unit may be split further into further sub-TUs. When a TU is not split further, it may be referred to as a leaf-TU. Generally, for intra coding, all the leaf-TUs belonging to a leaf-CU share the same intra prediction mode. That is, the same intra-prediction mode is generally applied to calculate predicted values for all TUs of a leaf-CU. For intra coding, a video encoder may calculate a residual value for each leaf-TU using the intra prediction mode, as a difference between the portion of the CU corresponding to the TU and the original block. A TU is not necessarily limited to the size of a PU. Thus, TUs may be larger or smaller than a PU. For intra coding, a PU may be collocated with a corresponding leaf-TU for the same CU. In some examples, the maximum size of a leaf-TU may correspond to the size of the corresponding leaf-CU.

Moreover, TUs of leaf-CUs may also be associated with respective quadtree data structures, referred to as residual quadtrees (RQTs). That is, a leaf-CU may include a quadtree indicating how the leaf-CU is partitioned into TUs. The root node of a TU quadtree generally corresponds to a leaf-CU, while the root node of a CU quadtree generally corresponds to a treeblock (or LCU). TUs of the RQT that are not split are referred to as leaf-TUs. In general, this disclosure uses the terms CU and TU to refer to leaf-CU and leaf-TU, respectively, unless noted otherwise.

A video sequence typically includes a series of video frames or pictures. A group of pictures (GOP) generally comprises a series of one or more of the video pictures. A GOP may include syntax data in a header of the GOP, a header of one or more of the pictures, or elsewhere, that describes a number of pictures included in the GOP. Each slice of a picture may include slice syntax data that describes an encoding mode for the respective slice. Video encoder 20 typically operates on video blocks within individual video slices in order to encode the video data. A video block may correspond to a coding node within a CU. The video blocks may have fixed or varying sizes, and may differ in size according to a specified coding standard.

As an example, the HM supports prediction in various PU sizes. Assuming that the size of a particular CU is 2N×2N, the HM supports intra-prediction in PU sizes of 2N×2N or N×N, and inter-prediction in symmetric PU sizes of 2N×2N, 2N×N, N×2N, or N×N. The HM also supports asymmetric partitioning for inter-prediction in PU sizes of 2N×nU, 2N×nD, nL×2N, and nR×2N. In asymmetric partitioning, one direction of a CU is not partitioned, while the other direction is partitioned into 25% and 75%. The portion of the CU corresponding to the 25% partition is indicated by an “n” followed by an indication of “Up”, “Down,” “Left,” or “Right.” Thus, for example, “2N×nU” refers to a 2N×2N CU that is partitioned horizontally with a 2N×0.5N PU on top and a 2N×1.5N PU on bottom.

In this disclosure, “N×N” and “N by N” may be used interchangeably to refer to the pixel dimensions of a video block in terms of vertical and horizontal dimensions, e.g., 16×16 pixels or 16 by 16 pixels. In general, a 16×16 block will have 16 pixels in a vertical direction (y=16) and 16 pixels in a horizontal direction (x=16). Likewise, an N×N block generally has N pixels in a vertical direction and N pixels in a horizontal direction, where N represents a nonnegative integer value. The pixels in a block may be arranged in rows and columns. Moreover, blocks need not necessarily have the same number of pixels in the horizontal direction as in the vertical direction. For example, blocks may comprise N×M pixels, where M is not necessarily equal to N.

Following intra-predictive or inter-predictive coding using the PUs of a CU, video encoder 20 may calculate residual data for the TUs of the CU. The PUs may comprise syntax data describing a method or mode of generating predictive pixel data in the spatial domain (also referred to as the pixel domain) and the TUs may comprise coefficients in the transform domain following application of a transform, e.g., a discrete sine transform (DST), a discrete cosine transform (DCT), an integer transform, a wavelet transform, or a conceptually similar transform to residual video data. The residual data may correspond to pixel differences between pixels of the unencoded picture and prediction values corresponding to the PUs. Video encoder 20 may form the TUs including the residual data for the CU, and then transform the TUs to produce transform coefficients for the CU.

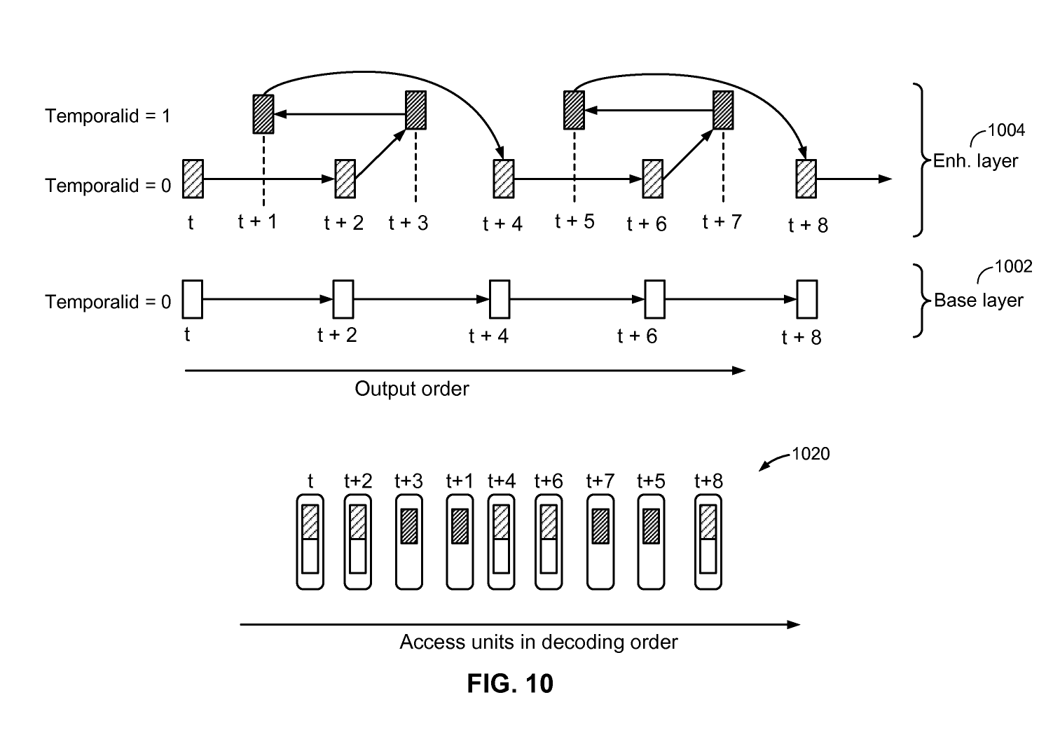

As discussed in greater detail below, the video encoder 20 or video decoder 30 may be configured to select a transform based upon one or more characteristics of the video being coded. For example, the transform may be selected based upon the transform unit size and video type (e.g., chroma, luma), among other characteristics. Methods of cross-layer alignment that may be implemented by the video encoder 20 or decoder 30 are described in greater detail below, including, for example, with respect to FIGS. 10 through 12.

Following any transforms to produce transform coefficients, video encoder 20 may perform quantization of the transform coefficients. Quantization is a broad term intended to have its broadest ordinary meaning. In one embodiment, quantization refers to a process in which transform coefficients are quantized to possibly reduce the amount of data used to represent the coefficients, providing further compression. The quantization process may reduce the bit depth associated with some or all of the coefficients. For example, an n-bit value may be rounded down to an m-bit value during quantization, where n is greater than m.

Following quantization, the video encoder may scan the transform coefficients, producing a one-dimensional vector from the two-dimensional matrix including the quantized transform coefficients. The scan may be designed to place higher energy (and therefore lower frequency) coefficients at the front of the array and to place lower energy (and therefore higher frequency) coefficients at the back of the array. In some examples, video encoder 20 may utilize a predefined scan order to scan the quantized transform coefficients to produce a serialized vector that can be entropy encoded. In other examples, video encoder 20 may perform an adaptive scan. After scanning the quantized transform coefficients to form a one-dimensional vector, video encoder 20 may entropy encode the one-dimensional vector, e.g., according to context-adaptive variable length coding (CAVLC), context-adaptive binary arithmetic coding (CABAC), syntax-based context-adaptive binary arithmetic coding (SBAC), Probability Interval Partitioning Entropy (PIPE) coding or another entropy encoding methodology. Video encoder 20 may also entropy encode syntax elements associated with the encoded video data for use by video decoder 30 in decoding the video data.

To perform CABAC, video encoder 20 may assign a context within a context model to a symbol to be transmitted. The context may relate to, for example, whether neighboring values of the symbol are non-zero or not. To perform CAVLC, video encoder 20 may select a variable length code for a symbol to be transmitted. Codewords in VLC may be constructed such that relatively shorter codes correspond to more probable symbols, while longer codes correspond to less probable symbols. In this way, the use of VLC may achieve a bit savings over, for example, using equal-length codewords for each symbol to be transmitted. The probability determination may be based on a context assigned to the symbol.

Video encoder 20 may further send syntax data, such as block-based syntax data, frame-based syntax data, and GOP-based syntax data, to video decoder 30, e.g., in a frame header, a block header, a slice header, or a GOP header. The GOP syntax data may describe a number of frames in the respective GOP, and the frame syntax data may indicate an encoding/prediction mode used to encode the corresponding frame.

### Video Encoder

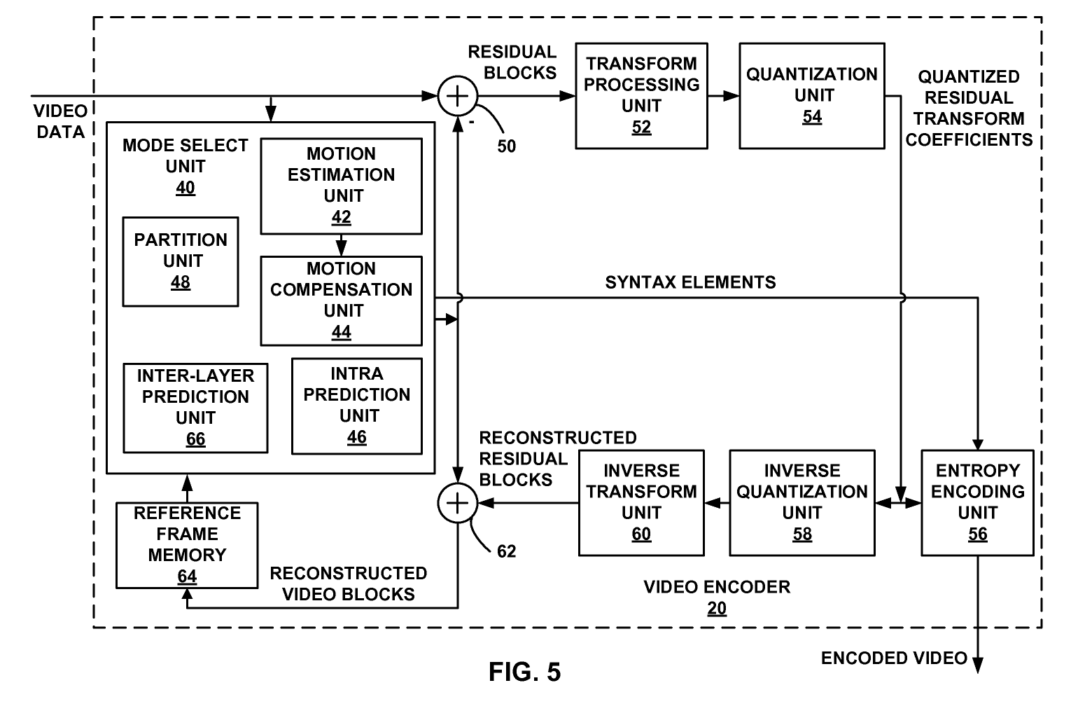

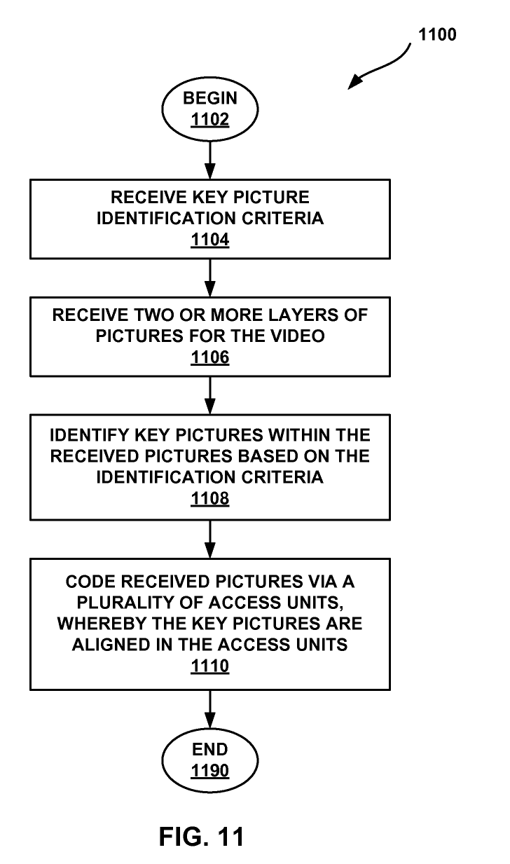

FIG. 5 is a block diagram illustrating an example of a video encoder that may implement techniques in accordance with aspects described in this disclosure. Video encoder 20 may be configured to perform any or all of the techniques of this disclosure, including but not limited to the methods of cross-layer alignment described in greater detail below with respect to FIGS. 10 and 11. As one example, transform processing unit 52 and inverse transform unit 60 may be configured to perform any or all of the techniques described in this disclosure. In another embodiment, the encoder 20 includes an optional inter-layer prediction unit 66 that is configured to perform any or all of the techniques described in this disclosure. In other embodiments, inter-layer prediction can be performed by mode selection unit 40, in which case the inter-layer prediction unit 66 may be omitted. However, aspects of this disclosure are not so limited. In some examples, the techniques described in this disclosure may be shared among the various components of video encoder 20. In some examples, in addition to or instead of, a processor (not shown) may be configured to perform any or all of the techniques described in this disclosure.

Video encoder 20 may perform intra-, inter-, and inter-layer prediction (sometime referred to as intra-, inter- or inter-layer coding) of video blocks within video slices. Intra coding relies on spatial prediction to reduce or remove spatial redundancy in video within a given video frame or picture. Inter-coding relies on temporal prediction to reduce or remove temporal redundancy in video within adjacent frames or pictures of a video sequence. Inter-layer coding relies on prediction based upon video within a different layer(s) within the same video coding sequence. Intra-mode (I mode) may refer to any of several spatial based coding modes. Inter-modes, such as uni-directional prediction (P mode) or bi-prediction (B mode), may refer to any of several temporal-based coding modes.

As shown in FIG. 5, video encoder 20 receives a current video block within a video frame to be encoded. In the example of FIG. 5, video encoder 20 includes mode select unit 40, reference frame memory 64, summer 50, transform processing unit 52, quantization unit 54, and entropy encoding unit 56. Mode select unit 40, in turn, includes motion compensation unit 44, motion estimation unit 42, intra-prediction unit 46, inter-layer prediction unit 66, and partition unit 48.

For video block reconstruction, video encoder 20 also includes inverse quantization unit 58, inverse transform unit 60, and summer 62. A deblocking filter (not shown in FIG. 5) may also be included to filter block boundaries to remove blockiness artifacts from reconstructed video. If desired, the deblocking filter would typically filter the output of summer 62. Additional filters (in loop or post loop) may also be used in addition to the deblocking filter. Such filters are not shown for brevity, but if desired, may filter the output of summer 50 (as an in-loop filter).

During the encoding process, video encoder 20 receives a video frame or slice to be coded. The frame or slice may be divided into multiple video blocks. Motion estimation unit 42 and motion compensation unit 44 perform inter-predictive coding of the received video block relative to one or more blocks in one or more reference frames to provide temporal prediction. Intra-prediction unit 46 may alternatively perform intra-predictive coding of the received video block relative to one or more neighboring blocks in the same frame or slice as the block to be coded to provide spatial prediction. Video encoder 20 may perform multiple coding passes, e.g., to select an appropriate coding mode for each block of video data.

Moreover, partition unit 48 may partition blocks of video data into sub-blocks, based on evaluation of previous partitioning schemes in previous coding passes. For example, partition unit 48 may initially partition a frame or slice into LCUs, and partition each of the LCUs into sub-CUs based on rate-distortion analysis (e.g., rate-distortion optimization, etc.). Mode select unit 40 may further produce a quadtree data structure indicative of partitioning of an LCU into sub-CUs. Leaf-node CUs of the quadtree may include one or more PUs and one or more TUs.

Mode select unit 40 may select one of the coding modes, intra, inter, or inter-layer prediction mode, e.g., based on error results, and provide the resulting intra-, inter-, or inter-layer coded block to summer 50 to generate residual block data and to summer 62 to reconstruct the encoded block for use as a reference frame. Mode select unit 40 also provides syntax elements, such as motion vectors, intra-mode indicators, partition information, and other such syntax information, to entropy encoding unit 56.

Motion estimation unit 42 and motion compensation unit 44 may be highly integrated, but are illustrated separately for conceptual purposes. Motion estimation, performed by motion estimation unit 42, is the process of generating motion vectors, which estimate motion for video blocks. A motion vector, for example, may indicate the displacement of a PU of a video block within a current video frame or picture relative to a predictive block within a reference frame (or other coded unit) relative to the current block being coded within the current frame (or other coded unit). A predictive block is a block that is found to closely match the block to be coded, in terms of pixel difference, which may be determined by sum of absolute difference (SAD), sum of square difference (SSD), or other difference metrics. In some examples, video encoder 20 may calculate values for sub-integer pixel positions of reference pictures stored in reference frame memory 64. For example, video encoder 20 may interpolate values of one-quarter pixel positions, one-eighth pixel positions, or other fractional pixel positions of the reference picture. Therefore, motion estimation unit 42 may perform a motion search relative to the full pixel positions and fractional pixel positions and output a motion vector with fractional pixel precision.

Motion estimation unit 42 calculates a motion vector for a PU of a video block in an inter-coded slice by comparing the position of the PU to the position of a predictive block of a reference picture. The reference picture may be selected from a first reference picture list (List 0) or a second reference picture list (List 1), each of which identify one or more reference pictures stored in reference frame memory 64. Motion estimation unit 42 sends the calculated motion vector to entropy encoding unit 56 and motion compensation unit 44.

Motion compensation, performed by motion compensation unit 44, may involve fetching or generating the predictive block based on the motion vector determined by motion estimation unit 42. Motion estimation unit 42 and motion compensation unit 44 may be functionally integrated, in some examples. Upon receiving the motion vector for the PU of the current video block, motion compensation unit 44 may locate the predictive block to which the motion vector points in one of the reference picture lists. Summer 50 forms a residual video block by subtracting pixel values of the predictive block from the pixel values of the current video block being coded, forming pixel difference values, as discussed below. In some embodiments, motion estimation unit 42 can perform motion estimation relative to luma components, and motion compensation unit 44 can use motion vectors calculated based on the luma components for both chroma components and luma components. Mode select unit 40 may generate syntax elements associated with the video blocks and the video slice for use by video decoder 30 in decoding the video blocks of the video slice.

Intra-prediction unit 46 may intra-predict or calculate a current block, as an alternative to the inter-prediction performed by motion estimation unit 42 and motion compensation unit 44, as described above. In particular, intra-prediction unit 46 may determine an intra-prediction mode to use to encode a current block. In some examples, intra-prediction unit 46 may encode a current block using various intra-prediction modes, e.g., during separate encoding passes, and intra-prediction unit 46 (or mode select unit 40, in some examples) may select an appropriate intra-prediction mode to use from the tested modes.

For example, intra-prediction unit 46 may calculate rate-distortion values using a rate-distortion analysis for the various tested intra-prediction modes, and select the intra-prediction mode having the best rate-distortion characteristics among the tested modes. Rate-distortion analysis generally determines an amount of distortion (or error) between an encoded block and an original, unencoded block that was encoded to produce the encoded block, as well as a bitrate (that is, a number of bits) used to produce the encoded block. Intra-prediction unit 46 may calculate ratios from the distortions and rates for the various encoded blocks to determine which intra-prediction mode exhibits the best rate-distortion value for the block.

After selecting an intra-prediction mode for a block, intra-prediction unit 46 may provide information indicative of the selected intra-prediction mode for the block to entropy encoding unit 56. Entropy encoding unit 56 may encode the information indicating the selected intra-prediction mode. Video encoder 20 may include in the transmitted bitstream configuration data, which may include a plurality of intra-prediction mode index tables and a plurality of modified intra-prediction mode index tables (also referred to as codeword mapping tables), definitions of encoding contexts for various blocks, and indications of a most probable intra-prediction mode, an intra-prediction mode index table, and a modified intra-prediction mode index table to use for each of the contexts.

The video encoder 20 may include an inter-layer prediction unit 66. Inter-layer prediction unit 66 is configured to predict a current block (e.g., a current block in the EL) using one or more different layers that are available in SVC (e.g., a base or reference layer). Such prediction may be referred to as inter-layer prediction. Inter-layer prediction unit 66 utilizes prediction methods to reduce inter-layer redundancy, thereby improving coding efficiency and reducing computational resource requirements. Some examples of inter-layer prediction include inter-layer intra prediction, inter-layer motion prediction, and inter-layer residual prediction. Inter-layer intra prediction uses the reconstruction of co-located blocks in the base layer to predict the current block in the enhancement layer. Inter-layer motion prediction uses motion information of the base layer to predict motion in the enhancement layer. Inter-layer residual prediction uses the residue of the base layer to predict the residue of the enhancement layer.

Video encoder 20 forms a residual video block by subtracting the prediction data from mode select unit 40 from the original video block being coded. Summer 50 represents the component or components that perform this subtraction operation. Transform processing unit 52 applies a transform, such as a discrete cosine transform (DCT) or a conceptually similar transform, to the residual block, producing a video block comprising residual transform coefficient values. Transform processing unit 52 may perform other transforms which are conceptually similar to DCT. For example, discrete sine transforms (DST), wavelet transforms, integer transforms, sub-band transforms or other types of transforms can also be used. In one embodiment, the transform processing unit 52 selects the transform based upon characteristics of the residual block. For example, the transform processing unit 52 may select the transform based upon a transform unit size and the color component type of the block being coded (e.g., luma, chroma).

Transform processing unit 52 can apply the transform to the residual block, producing a block of residual transform coefficients. The transform may convert the residual information from a pixel value domain to a transform domain, such as a frequency domain. Transform processing unit 52 may send the resulting transform coefficients to quantization unit 54. Quantization unit 54 quantizes the transform coefficients to further reduce bit rate. The quantization process may reduce the bit depth associated with some or all of the coefficients. The degree of quantization may be modified by adjusting a quantization parameter. In some examples, quantization unit 54 may then perform a scan of the matrix including the quantized transform coefficients. Alternatively, entropy encoding unit 56 may perform the scan.

Following quantization, entropy encoding unit 56 entropy encodes the quantized transform coefficients. For example, entropy encoding unit 56 may perform context adaptive variable length coding (CAVLC), context adaptive binary arithmetic coding (CABAC), syntax-based context-adaptive binary arithmetic coding (SBAC), probability interval partitioning entropy (PIPE) coding or another entropy coding technique. In the case of context-based entropy coding, context may be based on neighboring blocks. Following the entropy coding by entropy encoding unit 56, the encoded bitstream may be transmitted to another device (e.g., video decoder 30) or archived for later transmission or retrieval.

Inverse quantization unit 58 and inverse transform unit 60 apply inverse quantization and inverse transformation, respectively, to reconstruct the residual block in the pixel domain (e.g., for later use as a reference block). Motion compensation unit 44 may calculate a reference block by adding the residual block to a predictive block of one of the frames of reference frame memory 64. Motion compensation unit 44 may also apply one or more interpolation filters to the reconstructed residual block to calculate sub-integer pixel values for use in motion estimation. Summer 62 adds the reconstructed residual block to the motion compensated prediction block produced by motion compensation unit 44 to produce a reconstructed video block for storage in reference frame memory 64. The reconstructed video block may be used by motion estimation unit 42 and motion compensation unit 44 as a reference block to inter-code a block in a subsequent video frame.

### Cross-Alignment Processor

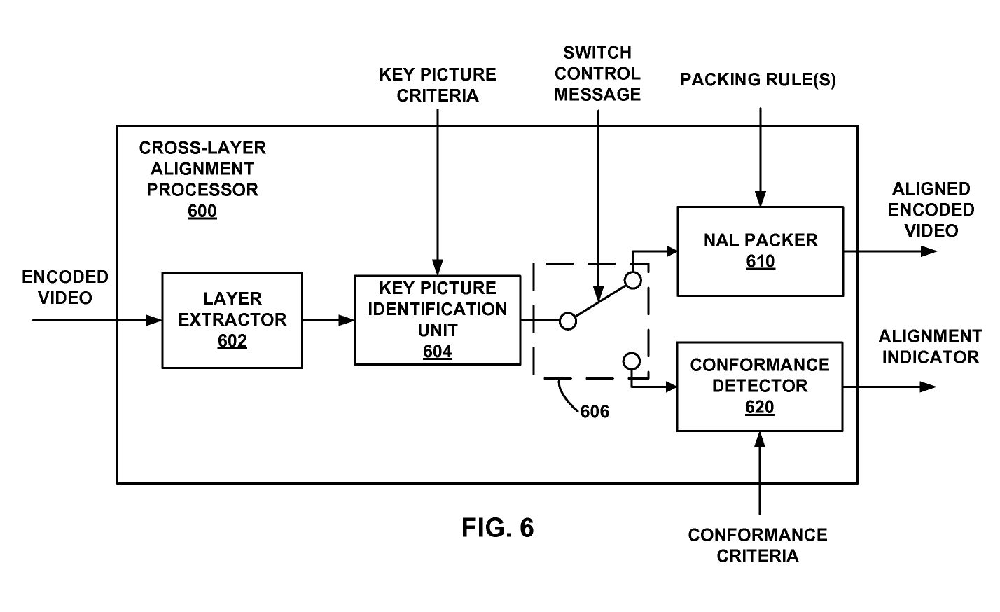

FIG. 6 is a block diagram illustrating an example of a cross-layer alignment processor that may implement techniques in accordance with aspects described in this disclosure. The cross-layer alignment processor 600 may be included in either the source device 12 or the destination device 14.

The cross-layer alignment processor 600 takes, as one input, encoded video information. A layer extractor 602 may be included to separate the picture information for reach layer included in the encoded video. In some implementations, where the cross-layer alignment processor 600 is included in an encoder, the picture information may be provided during the encoding process. In such implementations, it may not be necessary to extract the pictures but simply receive the picture information along with their associated layer information.

Each layer may include one or more pictures. The pictures may be organized within a layer into an output order. The output order identifies a sequence in which the pictures should be displayed. The output order may be specified by assigning an output position to each picture. When the pictures are arranged by their output positions (e.g., output position 0 being the first picture, output position 1 being the second picture, etc.) the pictures form the video sequence. The pictures may also be compressed or otherwise encoded. As such, some pictures may require information included in pictures having an output position before or after the picture of interest. Therefore, each picture is also associated with a decoding order. The decoding order identifies a decoding sequence for pictures included in a layer. Each picture is associated with a decoding position indicating when the picture can be decoded such that any predicate pictures are decoded prior to beginning the decoding of the picture.

The picture and layer information is provided to a key picture identification unit 604. The key picture identification unit 604 also receives a key picture criteria input. The key picture criteria input include information indicating the aspects of a picture which must be met to qualify as a key picture. For example, a key picture criteria may specify key pictures as pictures for which there is no other picture in the same layer that precedes the picture in decoding order and follows the picture in output order. The key picture criteria may be expressed in terms of output position and decoding positions. In such an expression, a picture is a key picture when pictures within the same set of pictures in the same layer as the picture having an output position after the output position of the picture also have decoding positions which follow the picture. The key picture identification unit 604 may, for each picture, apply the key picture criteria to identify the key pictures. The identification may be added to the picture information such as via a header field. In some implementations, the identification may be stored in a memory (not shown), and used for further cross-layer alignment processing.

A switch 606 is included in the cross-layer alignment processor 600 shown in FIG. 6. The switch 606 allows the cross-layer alignment processor 600 to serve as both an organizer for encoded data to be transmitted and a conformance tester for received encoded data. The switch 606 is activated by a switch control message. The switch control message may be received from memory (e.g., configuration value), or dynamically determined during device operation such as based on a source for the encoded data received.

When implemented in the source device 12, the cross-layer alignment processor 600 may be configured to generate one or more network abstraction layer messages to carry the encoded video data to over a network. In some implementations, the cross-alignment processor 600 may be included in the video encoder 20 or in the output interface 22. The switch 606 may receive a control message indicating organizer mode. When so activated, a network abstraction layer packer 610 is configured to organize the pictures into one or more network abstraction layer units and into one or more access units.

The network abstraction layer packer 610 may receive packing rules identifying how the pictures may be packaged based on picture information such as the key picture identification information, decoding dependencies, temporal identifier, picture order count, and the like. For example, a packing rule may be provided specifying that when a picture of one layer in an access unit is a key picture, all pictures of other layers in the same access unit shall be key pictures. Another packing rule which may be implemented specifies that an intra-coded random access point (IRAP) access unit shall contain a picture for each layer that has at least one picture in the coded video sequence and all pictures in an IRAP access unit shall be IRAP pictures. Another packing rule may specify that an access unit with temporal identifier equal to 0 shall contain a picture for each layer that has at least one picture in the coded video sequence. Packing rules may be specified independently or in conjunction with one or more additional packing rules. The same packing rules may be applied for all video processed or dynamically selected based on, for example, the encoded video data, encoder configuration, device operating characteristics (e.g., available power, available bandwidth, available memory, available processor capacity, thermal state), or the like. The NAL packer 610 provides as an output the encoded data aligned.

It will be understood that the cross-layer alignment processor 600 shown in FIG. 6 is an example. It may be desirable to implement the cross-layer alignment processor 600 on an encoding device dedicated to packing. In such implementations, the switch 606 may be excluded and information provided from the key picture identification unit 604 to the NAL packer 610.

The cross-layer alignment processor 600 may be configured to generate a message indicating whether received encoded video data is cross-layer aligned. It may be desirable to include the conformance indication in an encoding device to ensure the alignment of the video data prior to transmission. It may be desirable to, in some implementations, include the cross-alignment processor 600 may in the video decoder 30 or in the input interface 28.

The switch 606 may receive a control message indicating alignment conformance detection mode. When so activated, a conformance detector 620 receives the video data and is configured to determine whether the encoded video data is aligned according to a conformance criteria. The conformance criteria is provided as another input to the conformance detector 620. The conformance criteria includes information indicating characteristics of the encoded video data which are associated with alignment. The characteristics may include inclusion of key pictures across layers for an access unit, temporal id for pictures included in an access unit, and/or decoding order for pictures included in an access unit. The conformance criteria may be received as part of transmitted video data either in-band or out of band. The conformance criteria may be statically configured such as via a memory in data communication with the cross-layer alignment processor. The conformance criteria may be dynamically retrieved based on, for example, the encoded video data, coder configuration, device operating characteristics (e.g., available power, available bandwidth, available memory, available processor capacity, thermal state), or the like.

The conformance detector 620 is configured to provide as one output an alignment indicator. In some implementations, the alignment indicator is a binary value indicating whether or not the received encoded video data is aligned. In some implementations, the alignment indicator may specify a degree of alignment such as a percent alignment. The output may be used in encoding devices to determine whether or not to transmit the encoded data. The output may be used in decoding devices to establish a decoding pipeline which may rely on the conforming network abstraction layer format to expedite the decoding process.

If properly implemented, the encoded video data output from an organizing configuration for the cross-layer alignment processor 600, when provided as an input to the cross-layer alignment processor 600 should provide a positive indication for conformance with the alignment criteria.

The cross-alignment processor 600 shown in FIG. 6 may be configured to perform any or all of the techniques of this disclosure, including but not limited to the aspects of the cross-layer alignment methods described in greater detail below with respect to FIGS. 11 through 13. In some examples, in addition to or instead of, a processor (not shown) or other electronic communication component such as a signal generator, input/output processor, or modem (not shown) may be configured to perform any or all of the techniques described.

### Video Decoder

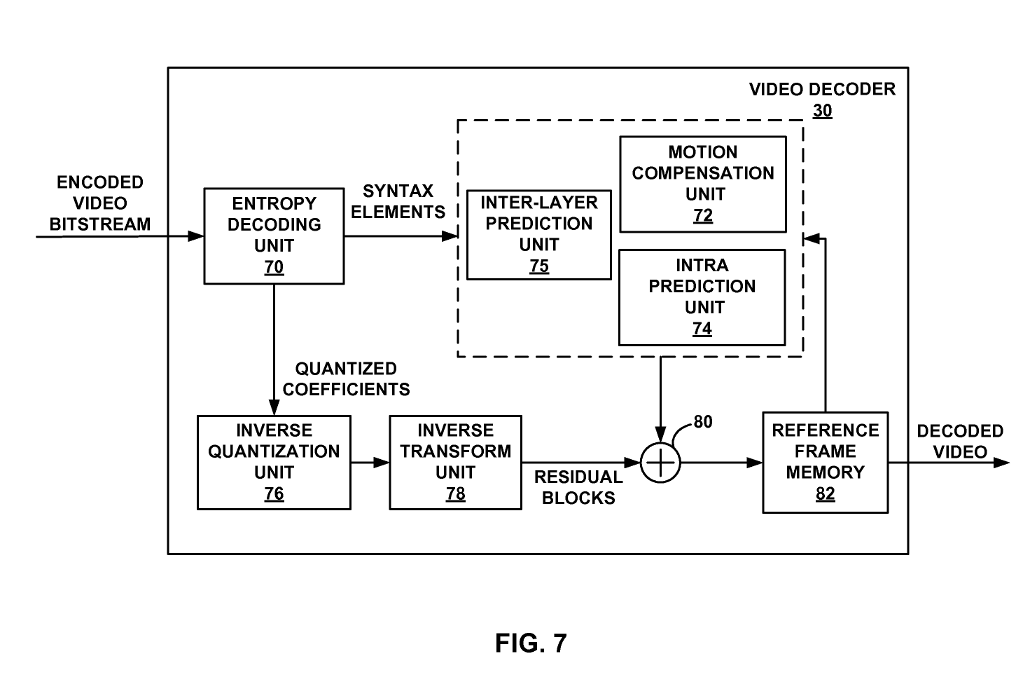

FIG. 7 is a block diagram illustrating an example of a video decoder that may implement techniques in accordance with aspects described in this disclosure. Video decoder 30 may be configured to perform any or all of the techniques of this disclosure, including but not limited to the aspects of the cross-layer alignment methods described in greater detail below with respect to FIGS. 11 through 13. As one example, inverse transform unit 78 may be configured to perform any or all of the techniques described in this disclosure. However, aspects of this disclosure are not so limited. In some examples, the techniques described in this disclosure may be shared among the various components of video decoder 30. In some examples, in addition to or instead of, a processor (not shown) may be configured to perform any or all of the techniques described in this disclosure.

In the example of FIG. 7, video decoder 30 includes an entropy decoding unit 70, motion compensation unit 72, intra prediction unit 74, inter-layer prediction unit 75, inverse quantization unit 76, inverse transformation unit 78, reference frame memory 82, and summer 80. In some embodiments, motion compensation unit 72 and/or intra prediction unit 74 may be configured to perform inter-layer prediction, in which case the inter-layer prediction unit 75 may be omitted. Video decoder 30 may, in some examples, perform a decoding pass generally reciprocal to the encoding pass described with respect to video encoder 20 (FIG. 5). Motion compensation unit 72 may generate prediction data based on motion vectors received from entropy decoding unit 70, while intra-prediction unit 74 may generate prediction data based on intra-prediction mode indicators received from entropy decoding unit 70.

During the decoding process, video decoder 30 receives an encoded video bitstream that represents video blocks of an encoded video slice and associated syntax elements from video encoder 20. Entropy decoding unit 70 of video decoder 30 entropy decodes the bitstream to generate quantized coefficients, motion vectors or intra-prediction mode indicators, and other syntax elements. Entropy decoding unit 70 forwards the motion vectors to and other syntax elements to motion compensation unit 72. Video decoder 30 may receive the syntax elements at the video slice level and/or the video block level.

When the video slice is coded as an intra-coded (I) slice, intra prediction unit 74 may generate prediction data for a video block of the current video slice based on a signaled intra prediction mode and data from previously decoded blocks of the current frame or picture. When the video frame is coded as an inter-coded (e.g., B, P or GPB) slice, motion compensation unit 72 produces predictive blocks for a video block of the current video slice based on the motion vectors and other syntax elements received from entropy decoding unit 70. The predictive blocks may be produced from one of the reference pictures within one of the reference picture lists. Video decoder 30 may construct the reference frame lists, List 0 and List 1, using default construction techniques based on reference pictures stored in reference frame memory 92. Motion compensation unit 72 determines prediction information for a video block of the current video slice by parsing the motion vectors and other syntax elements, and uses the prediction information to produce the predictive blocks for the current video block being decoded. For example, motion compensation unit 72 uses some of the received syntax elements to determine a prediction mode (e.g., intra- or inter-prediction) used to code the video blocks of the video slice, an inter-prediction slice type (e.g., B slice, P slice, or GPB slice), construction information for one or more of the reference picture lists for the slice, motion vectors for each inter-encoded video block of the slice, inter-prediction status for each inter-coded video block of the slice, and other information to decode the video blocks in the current video slice.

Motion compensation unit 72 may also perform interpolation based on interpolation filters. Motion compensation unit 72 may use interpolation filters as used by video encoder 20 during encoding of the video blocks to calculate interpolated values for sub-integer pixels of reference blocks. In this case, motion compensation unit 72 may determine the interpolation filters used by video encoder 20 from the received syntax elements and use the interpolation filters to produce predictive blocks.

Video decoder 30 may also include an inter-layer prediction unit 75. The inter-layer prediction unit 75 is configured to predict a current block (e.g., a current block in the EL) using one or more different layers that are available in SVC (e.g., a base or reference layer). Such prediction may be referred to as inter-layer prediction. Inter-layer prediction unit 75 utilizes prediction methods to reduce inter-layer redundancy, thereby improving coding efficiency and reducing computational resource requirements. Some examples of inter-layer prediction include inter-layer intra prediction, inter-layer motion prediction, and inter-layer residual prediction. Inter-layer intra prediction uses the reconstruction of co-located blocks in the base layer to predict the current block in the enhancement layer. Inter-layer motion prediction uses motion information of the base layer to predict motion in the enhancement layer. Inter-layer residual prediction uses the residue of the base layer to predict the residue of the enhancement layer.

Inverse quantization unit 76 inverse quantizes, e.g., de-quantizes, the quantized transform coefficients provided in the bitstream and decoded by entropy decoding unit 70. The inverse quantization process may include use of a quantization parameter QPY calculated by video decoder 30 for each video block in the video slice to determine a degree of quantization and, likewise, a degree of inverse quantization that should be applied.

Inverse transform unit 78 applies an inverse transform, e.g., an inverse DCT, an inverse DST, an inverse integer transform, or a conceptually similar inverse transform process, to the transform coefficients in order to produce residual blocks in the pixel domain. In one embodiment, the inverse transform unit 78 selects the particular transform to apply based upon one or more characteristics of the video information being decoded. For example, the inverse transform unit 78 may select the transform based upon the transform unit size and color component type of the video information.

After motion compensation unit 72 generates the predictive block for the current video block based on the motion vectors and other syntax elements, video decoder 30 forms a decoded video block by summing the residual blocks from inverse transform unit 78 with the corresponding predictive blocks generated by motion compensation unit 72. Summer 90 represents the component or components that perform this summation operation. If desired, a deblocking filter may also be applied to filter the decoded blocks in order to remove blockiness artifacts. Other loop filters (either in the coding loop or after the coding loop) may also be used to smooth pixel transitions, or otherwise improve the video quality. The decoded video blocks in a given frame or picture are then stored in reference picture memory 92, which stores reference pictures used for subsequent motion compensation. Reference frame memory 82 also stores decoded video for later presentation on a display device, such as display device 32 of FIG. 4.

### Cross-Layer Aligned Coding

The following embodiments may be applied with, for example, SHVC WD1 and MV-HEVC WD3 video encoding and decoding techniques. In many embodiments, the access unit discussed below is similar to the network abstraction layer units used in SVC and MVC, e.g., such that an access unit (AU) consists of all the coded pictures associated with the same output time and their associated non-VCL (video coding layer) network abstraction layer (NAL) units.

A group of pictures (GOP) structure may be used to refer to temporal prediction structures, e.g. hierarchical B coding structures, etc. Each GOP includes one key picture and a number of associated non-key pictures. The non-key pictures follow the key picture in decoding order but precede the key picture in output order, similarly as an IRAP picture and its associated leading pictures. In one embodiment, an IRAP picture and its associated leading pictures are one example of a GOP including a key picture and associated non-key pictures.

Such an AU implicitly requires cross-layer alignment of key pictures and non-key pictures if each AU includes a picture for each layer, but not otherwise. For example, such an AU does not guarantee cross-layer key picture alignment when different layers have different picture rates.

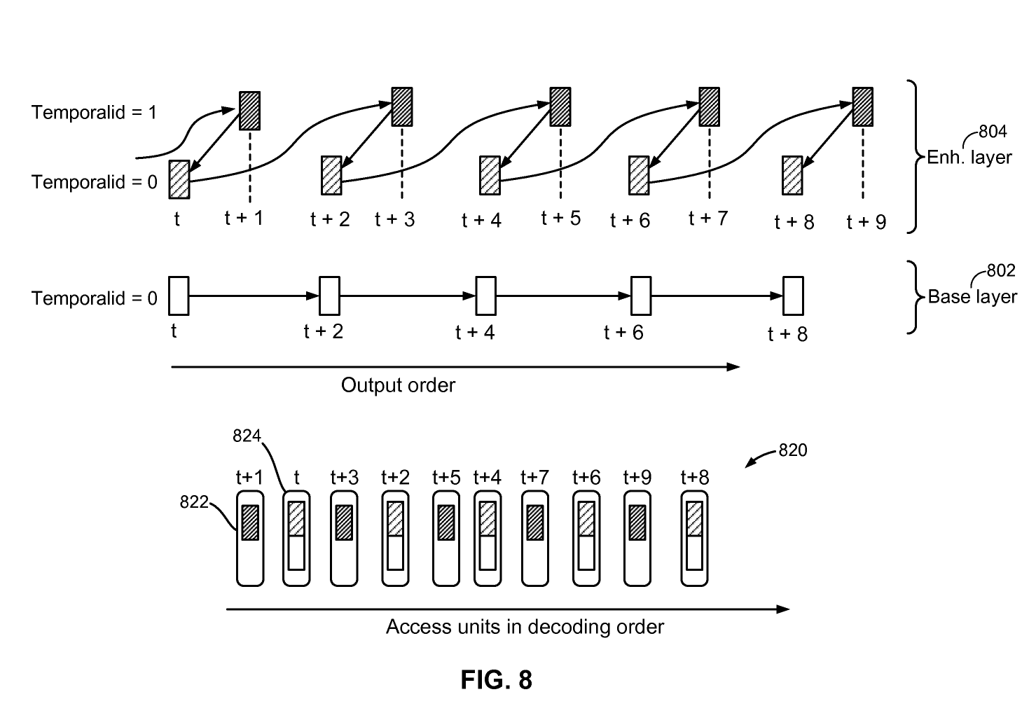

FIG. 8 illustrates an example of unaligned coded access units. The key pictures included in FIG. 8 are not aligned. The access units in FIG. 8 are included in one of a base layer 802 or an enhancement layer 804. While only one enhancement layer is shown in FIG. 8, it will be appreciated that the cross-layer alignment methods described may be applied to video encoded with additional enhancement layers.

The base layer 802 includes five pictures. The enhancement layer 804 includes ten pictures. The pictures are illustrated in FIG. 8 in temporal order beginning on the left and increasing to the right. The temporal order corresponds to a display or output order for the pictures such that the pictures are presented to form a video sequence.

The pictures may be coded in a plurality of access units 820. The access units each include one or more picture from one or more layers. For example, the first access unit 822 includes the picture having temporal order number 1 from the enhancement layer 804. The second access unit 824 includes a picture from both the base layer 802 and the enhancement layer 804. It should be noted that the decoding order for the access units 820 is not the same as the output order. As shown in FIG. 8, the second access unit 824 includes pictures with the temporal (e.g., output) identifier of t+0 while the first access unit 822 includes a picture with the temporal identifier of t+1.

This difference in decoding order vis-à-vis output order arises in part because the pictures included in each layer at a given output time point may have different dependencies for decoding. Dependencies are illustrated in FIG. 8 using arrows. An arrow pointing from a first picture to a second picture indicated the second picture uses information from the first picture for decoding. For example, the picture at t+0 in the enhancement layer 804 references information from the picture at t+1 in the enhancement layer 804. Accordingly, the picture at t+0 cannot be decoded until the picture at t+1 is received and processed.

As shown in FIG. 8, the picture at t+1 of the enhancement layer 804 is independently decodable. Similarly, the picture at t+0 of the base layer 802 is independently decodable. However, these pictures may not be included in the same access unit. As a result of the key pictures not being aligned, processing of the access units includes organizing the key pictures. Such reordering of pictures can add delay and increase conformance testing costs without substantial benefit.

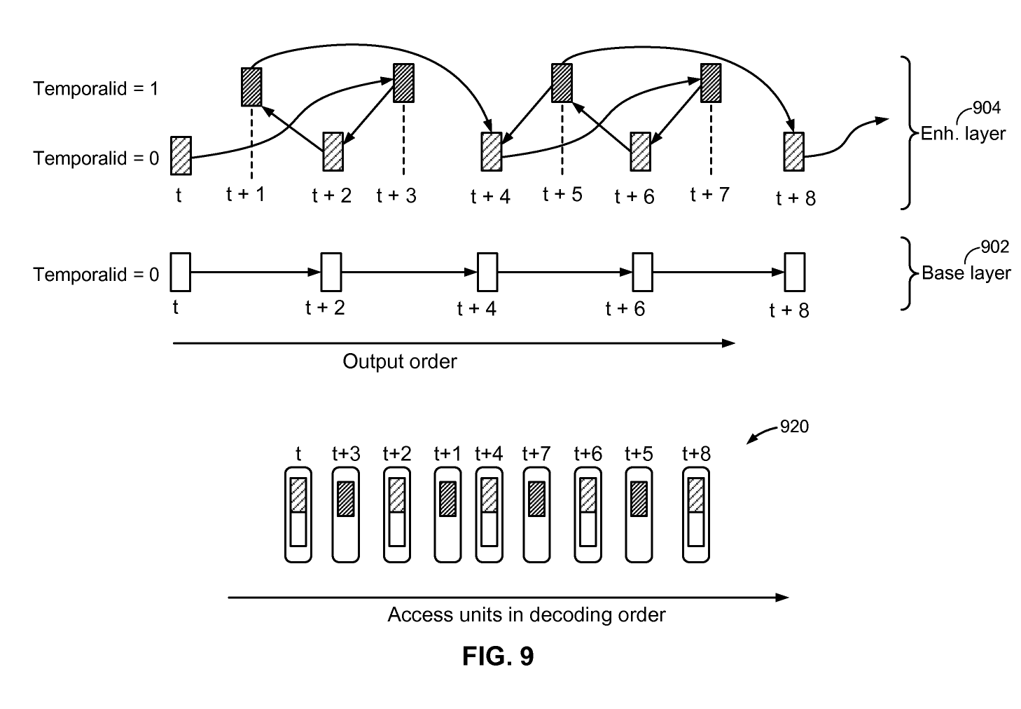

In addition, there may be bitstreams where the relative decoding order of all pictures at a particular layer and with a particular temporal identifier value is not the same as their output order. One example of such a bitstream is described below in reference to FIG. 9.

FIG. 9 illustrates a further example of unaligned coded access units. Similar to FIG. 8, the key pictures in FIG. 9 are not aligned and thus may exhibit similar inefficiencies during coding. FIG. 9 includes a base layer 902 and an enhancement layer 904. The base layer 902 includes five pictures while the enhancement layer 904 includes nine pictures. As in FIG. 8, the pictures in FIG. 9 are illustrated in temporal order beginning on the left and increasing to the right. The temporal order corresponds to a display or output order for the pictures such that the pictures are presented to form a video sequence. The pictures may be coded in a plurality of access units 920 similar to the pictures discussed with reference to FIG. 8. However, like FIG. 8, the key pictures for the layers are not aligned which can lead to resource inefficiencies. As shown in FIG. 9, the flexibility that the pictures at a particular layer and temporal identifier have different decoding order than the output order does not necessarily provide any benefit, but adds delay, resource consumption, etc.

FIG. 10 illustrates an example of aligned coded access units. FIG. 10 includes a base layer 1002 and an enhancement layer 1004. The base layer 1002 includes five pictures while the enhancement layer 1004 includes nine pictures. As in FIGS. 8 and 9, the pictures in FIG. 10 are illustrated in temporal order beginning on the left and increasing to the right. The temporal order corresponds to a display or output order for the pictures such that the pictures are presented to form a video sequence. The pictures may be coded in a plurality of access units 1020. Unlike FIGS. 8 and 9, however, the access units 1020 are coded such that key pictures are included in the same access unit. For example, the first access unit at time t+0 includes the picture t+0 from the enhancement layer and the picture t+0 from the base layer. This ensures that the coded video information is cross-layer aligned for increased efficiency processing. FIG. 10 illustrates an example of a bitstream where the key pictures are aligned, but the pictures with same TemporalId value (in this example TemporalId=1) are not required to have the same output order as the decoding order. This strikes a balance between the flexibility in coding and cross-layer alignment of key pictures.

FIG. 10 provides one illustration of a desirable, aligned coding. Described herein are several aspects which may be included in one or more implementations to provide the beneficial features described.

In various embodiments, one or more video encoding and decoding methods or devices may be configured to identify key and non-key pictures. As mentioned briefly, a key picture may be a picture included in a layer which is decodable without referencing any pictures having an output order prior to the picture. As such, the key picture may be used to decode pictures which are to be outputted after the key picture, but not prior.

Having identified key pictures, the method or device may be configured to process the video information such that an access unit including pictures from multiple layers, when a key picture for one layer at a display point in time is included, the other pictures from the other layers at the display point in time are also key pictures. In other words, when a picture of one layer in an access unit is a key picture, all pictures of other layers in the same access unit shall be key pictures for the same temporal identifier (e.g., presentation time). By processing the video information according to this method, it is ensured that the key pictures are aligned across layers.

A key picture does not use any other picture later in output order for inter prediction reference, and the relative output order between any two key pictures of a layer is the same as the relative decoding order. Cross-layer alignment of key pictures implies cross-layer alignment of non-key pictures.

With the above, an access unit containing key pictures may be referred to as a key access unit, and an access unit not containing key pictures may be referred to as non-key access unit. IRAP pictures are by definition all key pictures.

In identifying key pictures, the pictures which are not identified as key pictures may be referred to as non-key pictures. A non-key picture is a picture that follows another picture in the same layer in decoding order and precedes the another picture in output order.

Table 1 shows information for a simplified group of pictures of a layer of video data. Table 1 highlights how a picture is determined to be a “key picture” in one implementation.

TABLE 1

| | | | Key |
|---|---|---|---|
| Display Order | Dependency | Decode Order | Picture? |
| 0 | None | 0 | Yes |
| 1 | 2 | 3 | No |
| 2 | 0 and 4 | 2 | No |
| 3 | 2 | 4 | No |
| 4 | 1 | 1 | Yes |

The picture having display order of 0 is decodable without the use of any pictures having an output order prior to the picture for decoding. The display order for a picture may, in some implementations, be indicated by a temporal identifier associated with the picture. By virtue of having no dependencies, the independence of the picture having display order of 0 is confirmed as being key. Accordingly, in this example implementation, the picture having display order of 0 is a key picture.

As shown in Table 1, however, a picture may have a dependency and still be identified as a key picture. Take the picture having display order of 4. This picture depends on picture 1. However, because picture 1 is previously decoded and does not have an output order prior to picture 4, picture 4 may be identified as a key picture.

Contrast pictures 0 and 4 with picture having display order 1, for example. Picture 1 depends on picture 2 and has a decoding order of 3. Because picture 1 requires a picture having a later output position for decoding, picture 1 is not identified as a key picture. In other words, picture 1 is identified in this example as a non-key picture.

Table 1 illustrates one group of pictures for a single layer. The identification of key pictures may be performed for each layer included in the video stream. Once the key pictures are identified, the access units may be constructed such that each access unit including a key picture for a first layer only includes other key pictures from other layers, if additional pictures are to be included in the access unit.

As another illustration, the pictures included in the base layer 802 of FIG. 8 are all key pictures. However, note that in some implementations, not all base layer pictures are necessarily key pictures. For instance, the prediction relationship, such as the relationship illustrated for the enhancement layer 804, could also be applied to a base layer.

Table 2 shows a hypothetical identification of key pictures for respective groups of pictures associated with two layers of video information.

TABLE 2

| Layer | Temporal Id | Key? | Access Unit |
|---|---|---|---|
| Base | 0 | Yes | 1 |
| Base | 2 | No | 3 |
| Base | 4 | Yes | 2 |
| Enhancement | 0 | Yes | 1 |
| Enhancement | 1 | No | 4 |
| Enhancement | 2 | No | 3 |
| Enhancement | 3 | No | 5 |
| Enhancement | 4 | Yes | 2 |

As illustrated in Table 2, the base layer picture having temporal identifier 0 is included in the access unit 1 along with the enhancement layer picture with temporal identifier 0. This represents an alignment of key pictures. Furthermore, the alignment also represents an alignment of key pictures having the same output identifier. However, this may not necessarily be required for all implementations. For example, an enhancement layer may include multiple key pictures which may not align with the key pictures included in the base layer. As such, the key pictures in the enhancement layer may be included individually in access units (e.g., one key picture per access unit) and/or combined with a key picture from the base layer having a different temporal identifier.

In some implementations, the system or method may be configured to align pictures by identifying a special class of key pictures. Restrictions may be imposed on key and non-key pictures, similar to those applied to IRAP and leading pictures, to only require the alignment of certain key pictures. These special key pictures will be referred to herein as “boundary key pictures.”

A boundary key picture generally refers to a key picture which has leading non-key pictures, if any, that precede, in decoding order, the next key picture in output order. If a key picture has no preceding pictures in either output or decoding order, the picture is a boundary key picture. Once identified, the boundary key pictures may be aligned across layers by ensuring any access unit including a boundary key picture for a first layer includes boundary key picture(s) from other layers, if any. Leading non-key pictures of a key picture are those non-key pictures that succeed the key picture in decoding order and precede the key picture in output order. A picture which is not identified as a key picture and is not identified as a leading non-key picture may be referred to as a training non-key picture.

Using the example shown in Table 1, the pictures 0 and 4 are boundary key pictures. In relation to picture 4, pictures 1 through 3 would be identified as leading non-key pictures. In packaging the pictures into access units, a single access unit including one boundary key picture may only include other boundary key pictures, if any additional pictures are to be included in the access unit.

With this description of boundary key picture, it should be clear that some key pictures may be identified which are not boundary key pictures. As such, a further restriction may be imposed by the device or method such that the only pictures which will be identified as a “key picture” are those which are “boundary key pictures.” This increases the restriction on which pictures may be identified as “key” and thus introduce more predictability into the coding system, device, or method.

Table 3 below illustrates a further example of the identification of pictures for respective groups of pictures associated with a layer of video information.

TABLE 3

| Output | Decode | | |
|---|---|---|---|
| Order | Order | Picture Type | Comments |
| 0 | 0 | Boundary Key | |
| 1 | 4 | Trailing non-key of 0 | |
| | | Leading non-key of 4 | |
| 2 | 3 | Trailing non-key of 0 | |
| | | Leading non-key of 4 | |
| 3 | 5 | Trailing non-key of 0 | |
| | | Leading non-key of 4 | |
| 4 | 1 | Key | Not a boundary key |
| | | | because of output |
| | | | order item 8 (‘next |
| | | | key picture’) has |
| | | | decode order before |
| | | | the leading non-key |
| | | | pictures 1-3 of item 4 |
| | | | (‘current key picture’) |
| 5 | 7 | Trailing non-key of 4 | |
| | | Leading non-key of 8 | |
| 6 | 6 | Trailing non-key of 4 | |
| | | Leading non-key of 8 | |
| 7 | 8 | Trailing non-key of 4 | |
| | | Leading non-key of 8 | |
| 8 | 2 | Boundary Key | |

In some implementations, a key picture may be defined in terms of the picture order count. A picture order count for a video stream identifies a particular count value for each picture included in the stream. When the pictures are arranged in ascending order based on the picture order counts, the pictures are in display order. In A key picture may be identified within a group of pictures, if the picture order count/identifier of a current picture is greater than the highest picture order count/identifier decoded for the current group of pictures, the current picture is a key picture.

Some methods or devices may be configured to code the video information such that the decoding order of all pictures with the same temporal identifier is the same as their output order. This feature may be applied independently by itself or together with other alignment features described.

Some methods or devices may be configured to code the video information such that an IRAP access unit contains a picture for each layer that has at least one picture in the coded video sequence and all pictures in an IRAP access unit shall be IRAP pictures. This feature may be applied independently by itself or together with other alignment features described.

Some methods or devices may be configured to code the video information such that an initial access unit for a video stream (e.g., access unit with temporal identifier of 0) contains a picture for each layer that has at least one picture in the coded video sequence. This feature may be applied independently by itself or together with other alignment features described.

Some methods or devices may be configured to code the video information such that a picture with network access layer (NAL) unit header identifier (“nuh_layer_id”) greater than 0 shall not be an IRAP picture unless for each lower layer that has at least one picture in the coded video sequence there is a picture in the access unit. This feature may be applied independently by itself or together alignment features described.

FIG. 11 illustrates a process flow diagram for a method of video coding. The method 1100 may be performed in whole or in part by one or more of the devices described above such as the encoding device of FIG. 3 or the cross-layer alignment processor 600 of FIG. 6. The method begins at node 1102. The method 1100 includes receiving, at node 1104, criteria for identifying key pictures. In some implementations, the key picture may be identified as a picture for which there is no other picture in the same layer having a decoding position that precedes the decoding position of the picture and has an output position that follows the output position of the picture. In other implementations, the key picture may be identified as a boundary key picture if all the leading non-key pictures of the current key picture precede, in decoding order, the next key picture in output order. The criteria may be received in association with an associated video stream (e.g., in-band or out-of-band). The criteria may be received and stored in a memory for future use, such as a configuration. At node 1106, two or more layers of pictures for the video are received. At node 1108, the key pictures are identified based on the received criteria. At node 1110, the pictures are coded into access units, whereby within each access unit the key pictures are cross-layer aligned. Alignment of the key pictures includes coding the key picture for a first layer along with a key picture from another layer. Alignment also implies that no single access unit will include both key and non-key pictures. The method 1100 ends at node 1190 but may be repeated to code additional pictures.

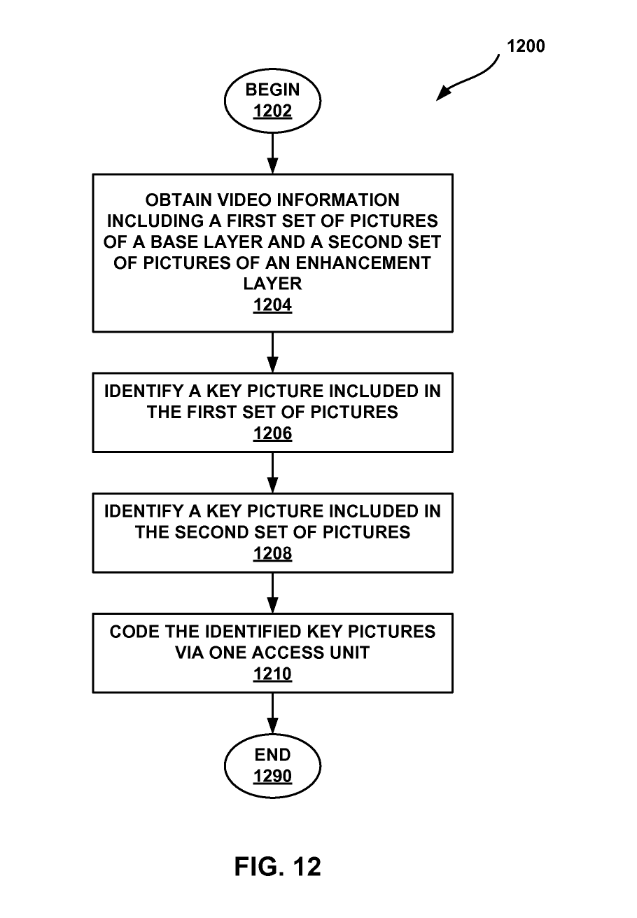

FIG. 12 shows a process flow diagram for another method of video coding including cross-layer alignment. The method 1200 may be performed in whole or in part by one or more of the devices described above such as the encoding device of FIG. 3 or the cross-layer alignment processor 600 of FIG. 6.

The method 1200 begins at node 1202. The method 1200, at node 1204, obtains, such as from a memory or receiver, video information including a first set of pictures of a base layer and a second set of pictures of an enhancement layer. The first and second set may, in some implementations, be referred to as a group of pictures. The first set of pictures and the second set of pictures provide different representations of the video information. For example, the frame rate of each layer may be different. The first set of pictures and the second set of pictures each have an output order for pictures included in the respective set. The output order identifies a display sequence for the pictures in the set. Each picture in the set has an output position within the associated output order. Each layer also has a decoding order for pictures included in the respective set. The decoding order identifies a decoding sequence for the pictures included in the respective set. Each picture is further has a decoding position within the associated decoding order.

At node 1206, a first picture included in the first set of pictures is identified. The first picture identified has no other picture following the first picture in output order from the first set of pictures which have a decoding order that is prior to the first picture. In some implementations, the first picture may be identified such that pictures within the first set of pictures having an output position after the output position of the first picture also have a decoding position after the decoding position of the first picture. In some implementations, the identified picture may be referred to as a key picture.

At node 1208, a second picture included in the second set of pictures is identified. The second picture has no other picture following the second picture in output order from the second set of pictures which have a decoding order that is prior to the second picture. In some implementations, the second picture may be identified such that pictures within the second set of pictures having an output position after the output position of the second pictures also have a decoding position after the decoding position of the second picture. In some implementations, the identified second picture may be referred to as a key picture.

At node 1210, the identified first picture and the identified second picture are coded into one access unit. The method 1200 ends at node 1290. The method 1200 may be repeated for subsequent first and second sets of pictures associated with different representations of another portion (e.g., time segment) of the video.

While the above methods (e.g., the method 1100 and the method 1200) illustrate cross-layer alignment within a coded access unit, analogous cross-layer alignment features may be implemented in a decoder. By including these features on the decoding side, a bitstream may be determined to be cross-layer aligned. Once a bitstream is identified as cross-layer aligned, subsequent decoding of the bitstream may be adjusted to take advantage of the above referenced efficiencies.

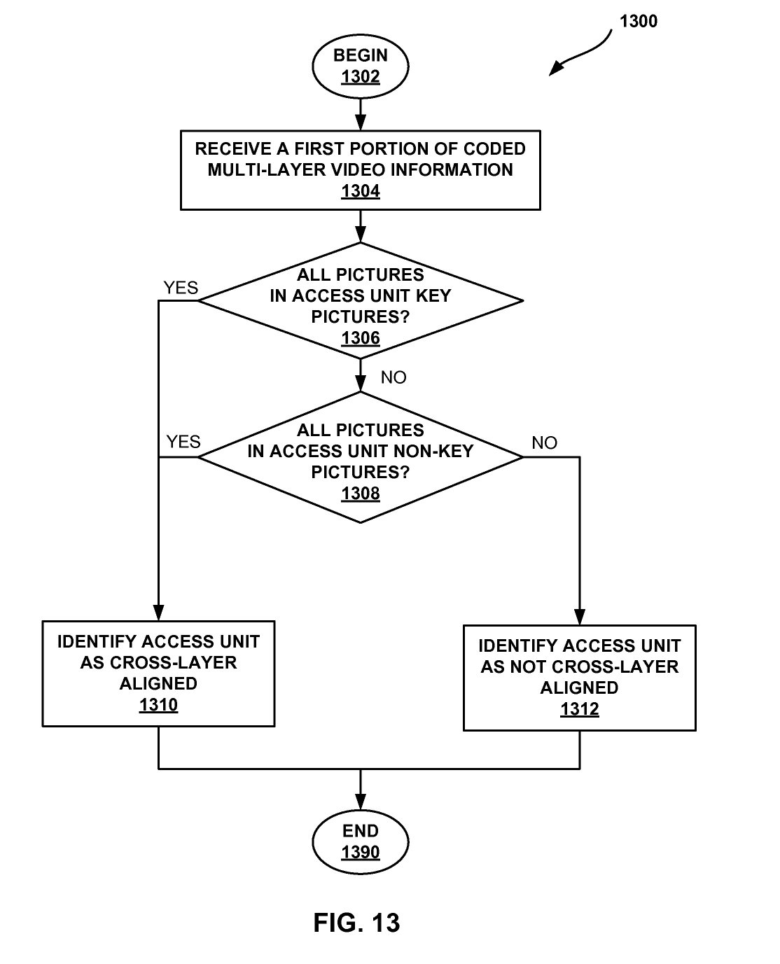

FIG. 13 shows a process flow diagram for a method of identifying cross-layer aligned video data. The method 1300 may be performed in whole or in part by one or more of the devices described above such as the decoding device of FIG. 4 or the cross-layer alignment processor 600 of FIG. 6.

At node 1304, a first portion of coded multi-layer video information is received, the first portion including a plurality of access units, each access unit including one or more pictures associated with a layer of the video. In some implementations, the first portion corresponds to a first group of pictures for a layer of the multi-layer video information. At node 1306, a determination is made as to whether an access unit of the plurality includes pictures that all are key pictures. The determination may include determining whether each picture in the access unit is a picture for which there is no other picture in the same layer having a decoding position that precedes the decoding position of the picture and has an output position that is after the output position of the picture. If the determination at node 1306 is positive, at node 1310, the access unit may be identified as cross-layer aligned. The determination at node 1306 may be repeated for each access unit included in the first portion. The method 1300 for the first portion ends at node 1390. The method 1300 may be repeated for other portions of the coded multi-layer video information.

If the determination at node 1306 for an access unit is negative, at node 1308, it is determined whether all the pictures included in the access unit are non-key pictures. If so, the method 1300 continues to node 1310 as described above. If not, the method 1300 continues to node 1310 where the access unit is identified as not being cross-layer aligned. The method 1300 may terminate upon a determination for an access unit at node 1390 as described above. In some implementations, the method may be performed for an initial set of pictures (e.g., first group of pictures). In such an implementation, the determination may be mixed such that some access units are identified as cross-layer aligned and others not cross-layer aligned. In some implementations, it may be desirable to provide a final determination for the video stream based on a single identification of non-alignment. As such, the method 1300 may terminate upon identification of one access unit as not being cross-layer aligned (see, node 1312).

In some implementations, the cross-layer alignment determination may be repeated with a subsequent portion of the video information. For example, the cross-layer alignment may vary based on transmission conditions such that a later portion of the multi-layer video information is transmitted in a cross-aligned format. In such as system, the identification process may be selectively performed. For example, the identification may be repeated after a configurable period of time such as a duration after an initial identification. The time may be marked, for example, temporally, by a quantity of video information received (e.g., the number of access units received), or by a quantity of video information processed. In some implementations, the selective identification may be performed based on operational characteristic of a decoding device such as the decoding device's processing load, thermal state, bandwidth capacity, memory capacity, or coupled hardware.

While the above disclosure has described particular embodiments, many variations are possible. For example, as mentioned above, the above techniques may be applied to 3D video encoding. In some embodiments of 3D video, a reference layer (e.g., a base layer) includes video information sufficient to display a first view of a video and the enhancement layer includes additional video information relative to the reference layer such that the reference layer and the enhancement layer together include video information sufficient to display a second view of the video. These two views can used to generate a stereoscopic image. As discussed above, picture information included in these layers may be aligned, in accordance with aspects of the disclosure. This can provide greater coding efficiency for a 3D video bitstream.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples have been described. These and other examples are within the scope of the following claims.

What is claimed is:

1. An apparatus for coding video information, the apparatus comprising:
a memory unit configured to store a first set of pictures included in a base layer and a second set of pictures included in an enhancement layer, said first set of pictures and said second set of pictures providing different representations of the video information, said first set of pictures and said second set of pictures having an output order for pictures included in the respective set, said output order identifying a display sequence for the pictures, each picture having an output position within the associated output order, said first set of pictures and said second set of picture having a decoding order for pictures included in the respective set, said decoding order identifying a decoding sequence for the pictures included in the respective set, each picture further having a decoding position within the associated decoding order; and
a video processor operationally coupled to the memory unit and configured to:
identify a first picture included in the first set of pictures, wherein pictures within the first set of pictures having an output position after the output position of the first picture also have a decoding position after the decoding position of the first picture;
identify a second picture included in the second set of pictures, wherein pictures within the second set of pictures having an output position after the output position of the second pictures also have a decoding position after the decoding position of the second picture; and
code the identified first picture and the identified second picture into one access unit.

2. The apparatus of claim 1, wherein the first set of pictures comprises a first group of pictures and the second set of pictures comprises a second group of pictures.

3. The apparatus of claim 1, wherein the pictures from the first set of pictures having output positions before the output position of the identified first picture and having decoding positions after the decoding position of the identified first picture also have decoding positions prior to a third picture included in a third set of pictures included in the base layer, wherein pictures within the third set of pictures have output positions after the output position of the third picture also have a decoding position after the decoding position of the third picture; and
wherein the pictures from the second set of pictures having output positions before the output position of the identified second picture and having decoding positions after the decoding position of the identified second picture also have decoding positions prior to a fourth picture included in a fourth set of pictures included in the enhancement layer, wherein pictures within the fourth set of pictures have output positions after the output position of the fourth picture also have decoding positions after the decoding position of the fourth picture.

4. The apparatus of claim 1, wherein the first picture and the second picture are intra-coded random access point pictures.

5. The apparatus of claim 1, wherein the access unit is a first access unit for the video information, and wherein the access unit includes a picture for each layer included the video information.

6. The apparatus of claim 1, wherein a picture associated with a layer other than the base layer shall not be coded as an intra-coded random access point picture unless, for each layer below the layer for the picture that has at least one picture in the video information there is a picture in the access unit.

7. The apparatus of claim 1, wherein the apparatus comprises an encoder configured to generate the access unit configured to align the pictures associated with the layers of an access unit.

8. The apparatus of claim 1, wherein the apparatus comprises a decoder configured to process the access unit configured to align the pictures associated with the layers of an access unit.

9. The apparatus of claim 1, wherein the apparatus includes a desktop computer, a notebook computer, a laptop computer, a tablet computer, a set-top box, a telephone handset, a television, a camera, a display device, a digital media player, a video gaming console, an in-car computer, or a video streaming device.

10. A method of encoding video information, the method comprising:
storing a first set of pictures included in a base layer and a second set of pictures included in an enhancement layer, said first set of pictures and said second set of pictures providing different representations of the video information, said first set of pictures and said second set of pictures having an output order for pictures included in the respective set, said output order identifying a display sequence for the pictures, each picture having an output position within the associated output order, said first set of pictures and said second set of picture having a decoding order for pictures included in the respective set, said decoding order identifying a decoding sequence for the pictures included in the respective set, each picture further having a decoding position within the associated decoding order;
identifying a first picture included in the first set of pictures, wherein pictures within the first set of pictures having an output position after the output position of the first picture also have a decoding position after the decoding position of the first picture;
identifying a second picture included in the second set of pictures, wherein pictures within the second set of pictures having an output position after the output position of the second pictures also have a decoding position after the decoding position of the second picture; and
encoding the identified first picture and the identified second picture in one access unit.

11. The method of claim 10, wherein the first set of pictures comprises a first group of pictures and the second set of pictures comprises a first group of pictures and a second group of pictures.

12. The method of claim 10, wherein the pictures from the first set of pictures having output positions before the output position of the identified first picture and having decoding positions after the decoding position of the identified first picture also have decoding positions prior to a third picture included in a third set of pictures included in the base layer, wherein pictures within the third set of pictures have output positions after the output position of the third picture also have a decoding position after the decoding position of the third picture; and
wherein the pictures from the second set of pictures having output positions before the output position of the identified second picture and having decoding positions after the decoding position of the identified second picture also have decoding positions prior to a fourth picture included in a fourth set of pictures included in the enhancement layer, wherein pictures within the fourth set of pictures have output positions after the output position of the fourth picture also have decoding positions after the decoding position of the fourth picture.

13. The method of claim 10, wherein the first picture and the second picture are intra-coded random access point pictures.

14. The method of claim 10, wherein the access unit is a first access unit for the video information, and wherein the access unit includes a picture for each layer included the video information.

15. The method of claim 10, wherein a picture associated with a layer other than the base layer shall not be coded as an intra-coded random access point picture unless, for each layer below the layer for the picture that has at least one picture in the video information there is a picture in the access unit.

16. A method of decoding video information, the method comprising:
receiving a first portion of the video information including two or more layers of pictures, each layer of pictures having an output order for pictures included in the respective layer, said output order identifying a display sequence for the pictures, each picture having an output position within the associated output order, said first set of pictures and said second set of picture having a decoding order for pictures included in the respective set, said decoding order identifying a decoding sequence for the pictures included in the respective set, each picture further having a decoding position within the associated decoding order;
identifying key pictures, a key picture being a picture having no other picture having an output position following the output position of the picture from pictures included in a layer associated with the picture which have a decoding position that is prior to the decoding position of the picture; and
decoding the video information based on a determination as to whether all pictures included in an access unit are identified key pictures.

17. The method of claim 16, wherein upon determining that all pictures included in the access unit are identified key pictures or that all pictures included in the access unit are not identified key pictures, configuring a decoding pipeline for cross-layer aligned decoding.

18. The method of claim 16, further comprising identifying key pictures wherein the pictures from a first set of pictures from a layer having output positions before the output position of the key picture and having decoding positions after the decoding position of the identified key picture also have decoding positions prior to another key picture included in the layer, wherein the another key picture is the next identified key picture in output order after the key picture.

19. The method of claim 18, wherein the first set of pictures comprises a first group of pictures included in a layer.

20. The method of claim 16, wherein a picture associated with a layer other than a base layer shall not be coded as an intra-coded random access point picture unless, for each layer below the layer for the picture that has at least one picture in the video information there is a picture in the access unit.

21. The method of claim 16, wherein said identifying is selectively performed.

22. The method of claim 21 wherein said identifying is performed based on an operational characteristic of a decoding device performing the method.

23. The method of claim 22, wherein the operational characteristic includes the decoding device processing load, thermal state, bandwidth capacity, memory capacity, or coupled hardware.

24. The method of claim 16, further comprising:
storing said determination as to whether all pictures included in an access unit are identified key pictures; and
selectively performing said identifying based on a duration of time elapsed since said determination.

25. An apparatus for coding video information, the apparatus comprising:
means for storing a first set of pictures included in a base layer and a second set of pictures included in an enhancement layer, said first set of pictures and said second set of pictures providing different representations of the video information, said first set of pictures and said second set of pictures having an output order for pictures included in the respective set, said output order identifying a display sequence for the pictures, each picture having an output position within the associated output order, said first set of pictures and said second set of pictures having a decoding order for pictures included in the respective set, said decoding order identifying a decoding sequence for the pictures included in the respective set, each picture further having a decoding position within the associated decoding order;
means for identifying a first picture included in the first set of pictures, wherein pictures within the first set of pictures having an output position after the output position of the first picture also have a decoding position after the decoding position of the first picture and for identifying a second picture included in the second set of pictures, wherein pictures within the second set of pictures having an output position after the output position of the second pictures also have a decoding position after the decoding position of the second picture; and
means for coding the identified first picture and the identified second picture into one access unit.

26. The apparatus of claim 25, wherein the first set of pictures comprises a first group of pictures and the second set of pictures comprises a first group of pictures and a second group of pictures.

27. The apparatus of claim 25, wherein the access unit is a first access unit for the video information, and wherein the access unit includes a picture for each layer included the video information.

28. The apparatus of claim 25, wherein a picture associated with a layer other than the base layer shall not be coded as an intra-coded random access point picture unless, for each layer below the layer for the picture that has at least one picture in the video information there is a picture in the access unit.

29. A non-transitory computer-readable medium comprising instructions executable by a processor of an apparatus, the instructions causing the apparatus to perform the video encoding method of claim 10.

30. A non-transitory computer-readable medium comprising instructions executable by a processor of an apparatus, the instructions causing the apparatus to perform the video decoding method of claim 16.
